(19) United States
(12) Patent Application Publication
(10) Pub. No.: US 2022/0327456 A1
(43) Pub. Date: Oct. 13, 2022

(54) INFORMATION PROCESSING APPARATUS, INFORMATION PROCESSING METHOD, AND RECORDING MEDIUM

(71) Applicant: LINK AND MOTIVATION INC., Tokyo (JP)

(72) Inventors: Yoshihisa OZASA, Tokyo (JP); Hideki SAKASHITA, Tokyo (JP)

(21) Appl. No.: 17/621,638

(22) PCT Filed: Mar. 18, 2020
(86) PCT No.: PCT/JP2020/011939

§ 371 Date: Dec. 21, 2021

(30) Foreign Application Priority Data
Jun. 24, 2019 (JP) 2019-116037

(51) Int. Cl. G06Q 10/06

(52) U.S. Cl. CPC G06Q 10/06395

(57) ABSTRACT

An information processing apparatus includes: an organization state information storage unit that stores organization state information regarding a state of an organization; a presentation information storage unit that stores one or more pieces of presentation information that is to be presented to a member of an organization; an output information acquiring unit that determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, using the organization state information; and a transmitting unit that transmits the piece of presentation information determined by the output information acquiring unit or output information that is the presentation information changed by the output information acquiring unit.

### TECHNICAL FIELD

The present invention relates to an information processing apparatus and the like that provide members of an organization with information, using organization state information regarding a state of the organization.

### BACKGROUND ART

Conventionally, there is a system capable of providing an individual belonging to a group, with advice for actions for improving a state of the group or the individual (see Patent Document 1).

Furthermore, there is an organization improvement activity assisting system for proposing a plan that matches a target organization, wherein the system accepts input of responses to question items regarding organization properties, from users of the organization, collects the responses, calculates an organization matching degree by quantifying the matching level to each of the contents that the organization properties can have, and proposes a recommended plan (see Patent Document 2).

### CITATION LIST

### Patent Document

Patent Document 1: JP 5854988B

Patent Document 2: JP 2016-053898A

### SUMMARY OF INVENTION

### Technical Problem

However, with the conventional techniques, it is impossible to appropriately provide the members of an organization with information, using organization state information regarding the state of the organization, in order to improve the organization.

### Solution to Problem

An information processing apparatus according to a first aspect of the present invention is an information processing apparatus including: an organization state information storage unit that stores organization state information regarding a state of an organization; a presentation information storage unit that stores one or more pieces of presentation information that is to be presented to a member of an organization; an output information acquiring unit that determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, using the organization state information; and an output information transmitting unit that transmits the piece of presentation information determined by the output information acquiring unit or output information that is the presentation information changed by the output information acquiring unit.

With such a configuration, it is possible to appropriately provide the members of an organization with information, using organization state information, in order to improve the organization.

An information processing apparatus according to a second aspect of the present invention is the information processing according to the first aspect of the invention, further including an organization state information acquiring unit that analyzes response information regarding a questionnaire directed to one or more members of the organization, to acquire organization state information, wherein the organization state information in the organization state information storage unit is the organization state information acquired by the organization state information acquiring unit.

With such a configuration, it is possible to appropriately provide the members of an organization with information, using organization state information acquired by analyzing response information regarding a questionnaire directed to the members of the organization, in order to improve the organization.

An information processing apparatus according to a third aspect of the present invention is the information processing according to the second aspect of the invention, wherein the organization state information acquiring unit performs statistical processing on response information regarding an questionnaire directed to two or members of the organization, to acquire organization state information that is an overall statistical processing result of the organization, or performs statistical processing on response information regarding an questionnaire directed to two or more members of a sector to which the two or more members of the organization belong, to acquire organization state information that is a statistical processing result of the sector, or acquires organization state information by using one or more kinds of information included in questionnaire responses from the members.

With such a configuration, it is possible to appropriately provide the members of an organization with information, using appropriate organization state information acquired by analyzing response information regarding a questionnaire directed to the members of the organization, in order to improve the organization.

An information processing apparatus according to a fourth aspect of the present invention is the information processing according to any one of the first to third aspects of the invention wherein the organization state information storage unit stores two or more pieces of organization state information, the information processing apparatus further comprises: a state-related information output unit that outputs two or more pieces of state-related information regarding the organization state information stored in the organization state information storage unit; and a selection accepting unit that accepts selection of one or more pieces of state-related information from among the two or more pieces of state-related information output by the state-related information output unit, and the output information acquiring unit determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, using one or more pieces of state-related information corresponding to the selection accepted by the selection accepting unit.

With such a configuration, it is possible to appropriately provide the members of an organization with information, using organization state information selected by a user, in order to improve the organization.

An information processing apparatus according to a fifth aspect of the present invention is the information processing according to any one of the first to third aspects of the invention, wherein the organization state information storage unit stores two or more pieces of organization state information, the information processing apparatus further comprises: an organization state information selecting unit that selects one or more pieces of organization state information that satisfy a predetermined state selection condition from among the two or more pieces of organization state information; a state-related information output unit that outputs two or more pieces of state-related information regarding the one or more pieces of organization state information selected by the organization state information selecting unit; and a selection accepting unit that accepts selection of one or more pieces of state-related information from among the two or more pieces of state-related information output by the state-related information output unit, and the output information acquiring unit determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, using one or more pieces of state-related information corresponding to the selection accepted by the selection accepting unit.

With such a configuration, it is possible to appropriately provide the members of an organization with information, using organization state information selected by a user from among pieces of organization state information that have automatically been selected, in order to improve the organization.

An information processing apparatus according to a sixth aspect of the present invention is the information processing according to any one of the first to third aspects of the invention, wherein the organization state information storage unit stores two or more pieces of organization state information, the information processing apparatus further comprises an organization state information selecting unit that selects one or more pieces of organization state information that satisfy a predetermined state selection condition from among the two or more pieces of organization state information, and the output information acquiring unit determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, using the one or more pieces of organization state information selected by the organization state information selecting unit.

With such a configuration, it is possible to appropriately provide the members of an organization with information, using organization state information that has automatically been selected, in order to improve the organization.

An information processing apparatus according to a seventh aspect of the present invention is the information processing according to any one of the first to sixth aspects of the invention, further including an action information receiving unit that receives action information regarding an action of a member performed in response to the output information transmitted by the output information transmitting unit; a statistical processing unit that performs statistical processing on the action information received by the action information receiving unit, to acquire a statistical processing result; and a statistical processing result output unit that outputs the statistical processing result.

With such a configuration, it is possible to perform statistical processing on information regarding actions performed in response to information presented to the members of an organization, and output the statistical processing result.

An information processing apparatus according to an eighth aspect of the present invention is the information processing according to any one of the first to sixth aspects of the invention, further including an action information receiving unit that receives action information regarding an action of a member performed in response to the output information transmitted by the output information transmitting unit, wherein the output information acquiring unit determines a piece of presentation information that is to be presented to a member of the organization, from among the pieces of presentation information stored in the presentation information storage unit, using the action information received by the action information receiving unit, and the output information transmitting unit transmits output information that is the piece of presentation information determined by the output information acquiring unit.

With such a configuration, it is possible to perform statistical processing on information regarding actions performed in response to information presented to the members of an organization, and appropriately provide the members of the organization with information, using the statistical processing result.

An information processing apparatus according to a ninth aspect of the present invention is the information processing according to the eighth aspect of the invention, wherein the output information transmitted by the output information transmitting unit is associated with organization state information, and the output information acquiring unit determines a piece of presentation information that is to be presented to a member of the organization, from among the pieces of presentation information stored in the presentation information storage unit, using the action information received by the action information receiving unit, and the organization state information associated with the output information.

With such a configuration, it is possible to perform statistical processing on information regarding actions performed in response to information presented to the members of an organization, and appropriately provide the members of the organization with information, using the statistical processing result.

An information processing apparatus according to a tenth aspect of the present invention is the information processing according to any one of the first to ninth aspects of the invention, wherein the organization state information storage unit stores first organization state information as of a first point in time that is earlier than when the output information transmitting unit transmits output information, and second organization state information as of a second point in time that is later than when the output information transmitter transmits output information, and the information processing apparatus further includes: a change information acquiring unit that acquires change information regarding a difference between the first organization state information and the second organization state information; and a change information output unit that outputs the change information acquired by the change information acquiring unit.

With such a configuration, it is possible to acquire and output a change in the state of an organization after providing information to a member of an organization, using organization state information, in order to improve the organization.

An information processing apparatus according to an eleventh aspect of the present invention is the information processing according to any one of the first to tenth aspects of the invention, further including an organization state information acquiring unit that analyzes first response information regarding a questionnaire directed to one or more members of the organization as of a first point in time that is earlier than when the output information transmitting unit transmits output information, to acquire first organization state information, and analyzes second response information regarding a questionnaire directed to one or more members of the organization as of a second point in time that is later than when the output information transmitting unit transmits output information, to acquire second organization state information; the information processing apparatus further includes: a change information acquiring unit that acquires change information regarding a difference between the first organization state information and the second organization state information; and a change information output unit that outputs the change information acquired by the change information acquiring unit.

With such a configuration, it is possible to, after providing information to the member of an organization, acquire organization state information acquired by analyzing response information regarding a questionnaire directed to the members of the organization, and acquire and output a change in the organization state information before and after the questionnaire is provided, using organization state information, in order to improve the organization.

An information processing apparatus according to a twelfth aspect of the present invention is the information processing according to any one of the first to eleventh aspects of the invention, wherein the organization state information is any one of one or more types of information of: first type organization state information regarding an overall statistical processing result that is a statistical processing result regarding the entire organization obtained by performing statistical processing on response information regarding a questionnaire directed to two or more members of the organization; second type organization state information regarding a sector statistical processing result that is a statistical processing result obtained by performing statistical processing on response information regarding a questionnaire directed to two or more members of the sector to which two or more members of the organization belong; and third type organization state information regarding a response to a questionnaire directed to each member, the output information acquiring unit determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, in association with a type identifier that identifies a type corresponding to the organization state information, using the organization state information, and the output information transmitting unit transmits output information that is the presentation information determined by the output information acquiring unit or the presentation information changed by the output information acquiring unit, in association with the type identifier.

With such a configuration, it is possible to clarify the range of the statistically processed questionnaire response information on which the information presented to the members of an organization is based.

### Advantageous Effects of Invention

With the information processing apparatus according to the present invention, it is possible to appropriately provide the members of an organization with information, using organization state information, in order to improve the organization.

### BRIEF DESCRIPTION OF DRAWINGS

FIG. 1 is a conceptual diagram for an information system A according to Embodiment 1.

FIG. 2 is a block diagram for the information system A according to the same.

FIG. 3 is a flowchart illustrating examples of operations of an information processing apparatus 1 according to the same.

FIG. 4 is a flowchart illustrating score calculation processing according to the same.

FIG. 5 is a flowchart illustrating an example of other processing performed to acquire an attribute value-considering overall score according to the same.

FIG. 6 is a diagram showing an item information management table according to the same.

FIG. 7 is a diagram showing organization response information according to the same.

FIG. 8 is a diagram showing an individual score table according to the same.

FIG. 9 is a diagram showing an organization information management table according to the same.

FIG. 10 is a diagram showing examples of outputs according to the same.

FIG. 11 is a conceptual diagram for an information system B according to Embodiment 2.

FIG. 12 is a block diagram for the information system B according to the same.

FIG. 13 is a block diagram for an information processing apparatus 3 according to the same.

FIG. 14 is a flowchart illustrating examples of operations of the information processing apparatus 3 according to the same.

FIG. 15 is a flowchart illustrating examples of operations of the information processing apparatus 3 according to the same.

FIG. 16 is a flowchart illustrating a first example of output information acquisition processing according to the same.

FIG. 17 is a flowchart illustrating output information forming processing according to the same.

FIG. 18 is a flowchart illustrating improvement item selection processing according to the same.

FIG. 19 is a flowchart illustrating an example of action information processing according to the same.

FIG. 20 is a flowchart illustrating an example of per-organization action information processing according to the same.

FIG. 21 is a flowchart illustrating an example of per-sector action information processing according to the same.

FIG. 22 is a flowchart illustrating an example of per-member action information processing according to the same.

FIG. 23 is a flowchart illustrating an example of change information acquisition processing according to the same.

FIG. 24 is a flowchart illustrating per-organization change information acquisition processing according to the same.

FIG. 25 is a flowchart illustrating per-sector change information acquisition processing according to the same.

FIG. 26 is a flowchart illustrating per-member change information acquisition processing according to the same.

FIG. 27 is a flowchart illustrating a second example of output information acquisition processing according to the same.

FIG. 28 is a flowchart illustrating examples of operations of a terminal apparatus 4 according to the same.

FIG. 29 is a flowchart illustrating examples of operations of a management terminal 5 according to the same.

FIG. 30 is a diagram showing a presentation information management table according to the same.

FIG. 31 is a diagram showing a first organization state information management table according to the same.

FIG. 32 is a diagram showing a second organization state information management table according to the same.

FIG. 33 is a diagram showing an example of a screen according to the same.

FIG. 34 is a schematic view of a computer system according to the above-described embodiments.

FIG. 35 is a block diagram for the computer system according to the same.

### DESCRIPTION OF EMBODIMENTS

Hereinafter, embodiments of an information processing apparatus and the like will be described with reference to the drawings. It should be noted that constituent elements denoted by the same reference numerals in the embodiments perform the same operations, and therefore redundant descriptions may be omitted.

### Embodiment 1

The present embodiment describes an information system that includes an information processing apparatus that calculates and outputs an attribute value-considering overall score. The attribute value-considering overall score is an overall score of an organization corresponding to an organization attribute value. Note that an overall score of an organization may also be referred to as an engagement score. The information system may also be referred to as an engagement system. The information processing apparatus may also be referred to as an engagement apparatus.

The present invention describes an information system that includes an information processing apparatus that stores two or more pieces of organization information that each include one or more organization attribute values and an overall score, and calculates and outputs different attribute value-considering overall scores according to an attribute value of the organization even if the absolute overall score is the same.

The present embodiment also describes an information system that includes an information processing apparatus that calculates and outputs an attribute value-considering overall score, using only organization response information that is paired with the same organization attribute value.

The present embodiment also describes an information system that includes an information processing apparatus that calculates an overall score that indicates a member's overall motivation, using responses from the member to multiple questions. Note that the plurality of questions are questions for measuring an expectation level and a satisfaction level of a member of an organization, regarding items.

The present embodiment also describes an information system that calculates a score based on an expectation level and a satisfaction level for each diagnosis area, and calculates an overall score, using the score.

Furthermore, the present embodiment describes an information system that calculates an overall score, using information regarding a satisfaction level regarding one or more of: an organization; a job; a supervisor; and a workplace, as well.

Note that the above overall score is one or more of: an absolute overall score; and an attribute value-considering overall score.

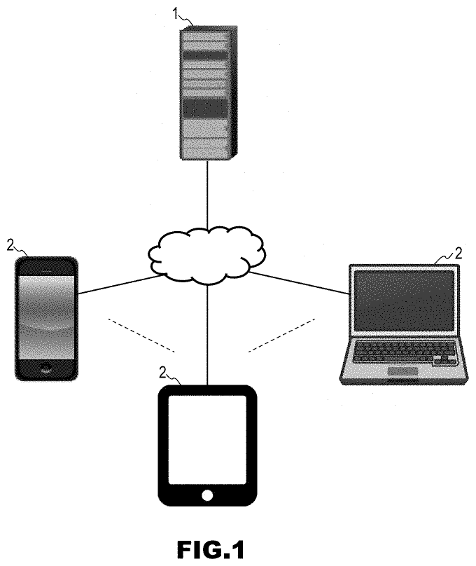

FIG. 1 is a conceptual diagram for an information system A according to the present embodiment. The information system A includes an information processing apparatus 1 and one or more terminal apparatuses 2. The information processing apparatus 1 in this example is a so-called server apparatus. The information processing apparatus 1 is, for example, a cloud server or an ASP server, and there is no limitation on the type or installation location thereof. Each terminal apparatus 2 is a mobile terminal such as a smartphone, a tablet device, or a mobile phone, a so-called personal computer, or the like, and there is no limitation on the type thereof.

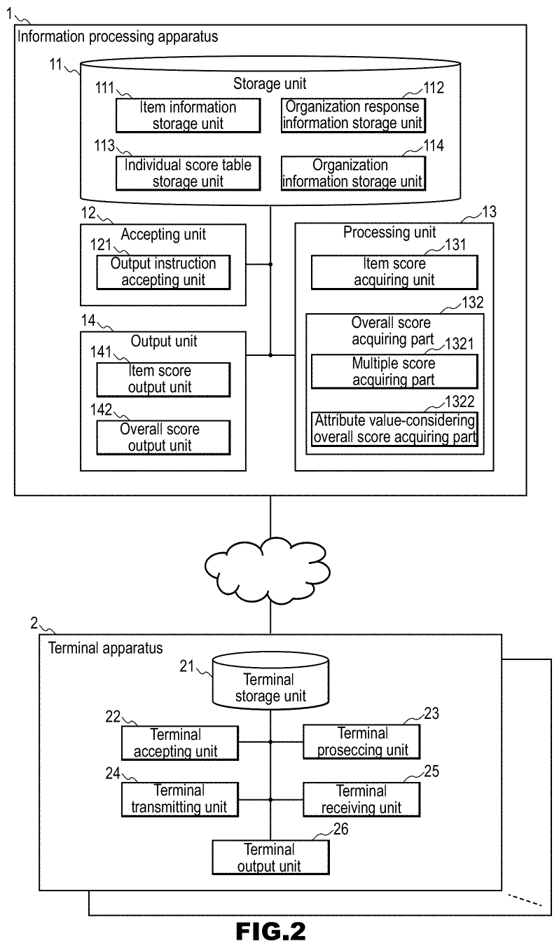

FIG. 2 is a block diagram for the information system A according to the present embodiment.

The information processing apparatus 1 included in the information system A includes a storage unit 11, an accepting unit 12, a processing unit 13, and an output unit 14.

The storage unit 11 includes, for example, an item information storage unit 111, an organization response information storage unit 112, an individual score table storage unit 113, and an organization information storage unit 114. The accepting unit 12 includes an output instruction accepting unit 121. The processing unit 13 includes an item score acquiring unit 131 and an overall score acquiring unit 132. The overall score acquiring unit 132 includes, for example, a multiple score acquiring part 1321 and an attribute value-considering overall score acquiring part 1322. The output unit 14 includes, for example, an item score output unit 141 and an overall score output unit 142.

Each terminal apparatus 2 includes a terminal storage unit 21, a terminal accepting unit 22, a terminal processing unit 23, a terminal transmitting unit 24, a terminal receiving unit 25, and a terminal output unit 26.

The storage unit 11 included in the information processing apparatus 1 stores various kinds of information. The various kinds of information are, for example, the later-described item information, the later-described organization response information, and the later-described individual score table. Note that the individual score table may also be referred to as an engagement score table.

The item information storage unit 111 stores two or more pieces of item information. Item information is information regarding an item of an organization. An item of an organization may also be referred to as an item regarding an organization. An item may be a question regarding an organization. An item may be associated with a question regarding an organization. The two or more items include, for example, an overall item regarding an overall matter of an organization, and an individual item, which is an individual item of the organization. Note that an overall item is typically an item for a question with a high abstraction degree. An individual item is typically an item for a question with a lower abstraction degree (a more specific question). The two or more pieces of item information in the item information storage unit 111 include, for example, item information regarding four overall items and item information regarding sixty-four individual items. Each item corresponds to, for example, any one of two or more targets. A target may also be referred to as a factor. A target may also be referred to as a matter regarding an organization. Item information includes, for example, an item identifier that identifies an item, and question information. An item identifier is, for example, an ID, an item name, or the like. An item identifier may also be question information itself. Question information is information indicating a question. Note that a question is typically a question in a questionnaire. Note that a matter may also be referred to as a target or an item.

The organization response information storage unit 112 stores organization response information regarding two or more organizations. Organization response information is information indicating a response to a question for a member of an organization. A question may also be referred to as a topic or an item.

Organization response information is typically associated with an organization identifier that identifies an organization. An organization identifier is an organization name, an ID that identifies an organization, or the like. Organization response information is typically associated with one or more organization attribute values, which are attribute values of an organization. Organization attribute value is, for example, an industry type identifier indicating an industry type of an organization (e.g., bank, apparel, manufacturer, etc.), a size identifier for classifying a size of an organization (e.g., large enterprise, small-to-medium sized enterprise, micro enterprise, self-employed, etc.), information indicating a category of an organization based on business conditions of an organization (e.g., in the black, in the red, etc.), a region identifier indicating the region of a home office, a sector identifier that identifies a sector in an organization (e.g., human-resources, accounting, laboratory, engineering sector, sales sector, manufacturing sector, etc.), a listing identifier indicating whether or not an organization is listed, a stage identifier indicating a stage of an organization (e.g., founding period, expansion period, diversification period, revitalization period, etc.), a business model identifier indicating a business model (e.g., innovator business that performs multiple types of businesses, professional business that performs a small number of businesses such as one business and depends on people, operator business that performs a small number of businesses such as one business and depends on systems, etc.), or the like. The industry type may be rough classification such as financing company, manufacturer, trading company, service industry, or the like, or fine classification such as bank, securities company, electronics manufacturer, food manufacturer, machine manufacturer, or the like. As a matter of course, there is no limitation on how to classify industry types, for example.

One piece of organization response information is a set of information regarding responses from two or more members of one organization. One piece of organization response information includes two or more pieces of member response information respectively corresponding to two or more members. Member response information is information that includes a response from a member to a question regarding an item. Member response information includes two or more pieces of item response information. Member response information typically includes the same number of pieces of item response information as the number of items. Item response information includes an item identifier and a response information. Response information is information regarding a response to a question. Response information includes, for example, satisfaction level information. Satisfaction level information is information indicating a response regarding a member's satisfaction level regarding an item. Satisfaction may be a similar positive factor such as fulfillment, achievement, excellence, or the like. Satisfaction level information is, for example, information for specifying a satisfaction level regarding an item. Satisfaction level information is classified into two or more classes. Satisfaction level information may take, for example, any natural number of 1 to 5. Note that satisfaction level information may be, for example, an evaluation value, such as A, B, and C, having the rank or order, or may be any natural number of 1 to 100, for example. Response information includes, for example, satisfaction level information and expectation level information. Expectation level information is information indicating a response regarding a member's expectation level regarding an item. Expectation may be a similar factor such as desire, emphasis, wish, or the like. Expectation level information is, for example, information for specifying an expectation level regarding an item. Expectation level information is classified into two or more classes. Expectation level information may take, for example, any natural number of 1 to 5. Note that expectation level information may be, for example, an evaluation value, such as A, B, and C, having the rank or order, or may be any natural number of 1 to 100, for example. There is no limitation on the content of an item, a question, and so on. A member is, for example, an employee of a company, a staff member of a school, a staff member of a government office, or the like, but it may be an executive of a company, for example. A member may be a part-time employee.

An overall item is, for example, a company satisfaction level indicating a level of being satisfied with a company, a job satisfaction level indicating a level of being satisfied with a job, a supervisor satisfaction level indicating a level of being satisfied with a supervisor, a workplace satisfaction level indicating a level of being satisfied with a workplace, or the like. An individual item is, for example, business superiority of a company, transmission and transfer of a strategic objective, a sense of overall solidarity, reasonableness of evaluation and salary, or the like.

The individual score table storage unit 113 stores an individual score table. The individual score table in this example is information that determines an item score when satisfaction level information and expectation level information are given. The individual score table in this example is, for example, a table having an axis of satisfaction level information and an axis of expectation level information, wherein table cells respectively show individual scores, so that an item score is determined when satisfaction level information and expectation level information are determined. Such an individual score table is preferably a table in which the larger the satisfaction level indicated by the satisfaction level information is, the larger the acquired item score is, and the smaller the expectation level indicated by the expectation level information is, the larger the acquired item score is.

The item score may also be determined using an operation expression that has satisfaction level information and expectation level information as parameters. It is preferable that such an operation expression is an increasing function that has satisfaction level information as a parameter, and is a decreasing function that has expectation level information as a parameter.

Furthermore, it is also possible to learn multiple sets of satisfaction level information, expectation level information, and an item score through machine learning, and determine an item score using the acquired learning information. In such a case, satisfaction level information and expectation level information are applied to learning information, and an item score is acquired through machine learning. Note that the machine learning here may be, for example, SVR, deep learning, decision trees, random forests, or the like. Note that there is no limitation on the algorithm for machine learning.

The organization information storage unit 114 stores two or more pieces of organization information. Organization information is information regarding an organization. Organization information includes an organization identifier and an organization attribute value. It is preferable that organization information includes an organization identifier, an organization attribute value, and an overall score that is an overall score of an organization. Overall score may be an absolute overall score that does not depend on an organization attribute value.

The accepting unit 12 accepts various kinds of information and instructions. The various kinds of information are, for example, the later-described output instruction, organization response information, questionnaire response information (member response information), and so on. Here, “acceptance” typically means receiving from the terminal apparatus 2, but it may be considered as a concept that also encompasses accepting information input from an input device such as a keyboard, a mouse, or a touch panel, accepting information read from a recording medium such as an optical disk, a magnetic disk, a semiconductor memory, or the like.

The output instruction accepting unit 121 accepts an output instruction. An output instruction is an instruction to output a score of an organization, and is an instruction that includes an organization identifier. Also, an output instruction is, for example, an instruction to output one or more kinds of scores of: an attribute value-considering overall score; an absolute overall score; and an item score. An output instruction may also include an attribute identifier that is used to acquire an attribute value-considering overall score. An attribute identifier is an information that identifies an attribute. An attribute identifier is, for example, “industry type”, “size”, “region”, “business status”, “sector”, “listing”, “stage”, “business model”, or the like. When an attribute identifier is “industry type”, an industry type identifier is used to acquire an attribute value-considering overall score. When an attribute identifier is “size”, a size identifier is used to acquire an attribute value-considering overall score. When an attribute identifier is “region”, a region identifier is used to acquire an attribute value-considering overall score. When an attribute identifier is “business status”, a business status identifier is used to acquire an attribute value-considering overall score. When an attribute identifier is “sector”, a sector identifier is used to acquire an attribute value-considering overall score. When an attribute identifier is “listing”, a listing identifier is used to acquire an attribute value-considering overall score. When an attribute identifier is “stage”, a stage identifier is used to acquire an attribute value-considering overall score. When an attribute identifier is “business model”, a business model identifier is used to acquire an attribute value-considering overall score.

An output instruction may also include an attribute value. An attribute value is, for example, “manufacturer”, “trading company”, “large enterprise”, “Tokyo”, “red”, “laboratory”, “unlisted”, “expansion period”, “professional”, or the like.

The processing unit 13 performs various kinds of processing. Various kinds of processing are, for example, processing that is performed by the item score acquiring unit 131, processing that is performed by the overall score acquiring unit 132, and so on. Various kinds of processing include, for example, processing that is performed to accumulate the received organization response information, the received questionnaire response information, the received organization information, and so on in the storage unit 11.

The item score acquiring unit 131 performs statistical processing on response information for the members regarding two or more items included in two or more pieces of organization response information, and acquires an item score for each organization and each item.

For example, for each organization, the item score acquiring unit 131 performs statistical processing on satisfaction level information included in response information regarding two or more items included in the organization response information regarding the organization, and acquires an item score for each organization and each item. For example, the item score acquiring unit 131 may calculate an average value of satisfaction level information for each organization and each item, and accumulate such an average value as an item score in a buffer (not shown) or the storage unit 11 in pair with the item identifier. For example, the item score acquiring unit 131 may calculate a weighted average value of satisfaction level information for each organization and each item by weighting differently according to the attribute values of the members, and accumulate such an average value as an item score in a buffer (not shown) or the storage unit 11 in pair with the item identifier. Note that an attribute value of a member is, for example, a position, a length of service, the sex, or the like. For example, the item score acquiring unit 131 may calculate a weighted average value while making the weight of the satisfaction level information regarding a long-service employee greater than that of a short-service employee.

The item score acquiring unit 131 acquires, for each organization, item scores of at least some of the items, using satisfaction level information and expectation level information. Note that an item for which an item score is acquired using satisfaction level information and expectation level information is, for example, an individual item.

It is preferable that the item score acquiring unit 131 acquires an item score so that the higher the satisfaction level information is, the higher the score is, and the lower the expectation level information is, the higher the score is, for example.

The item score acquiring unit 131 calculates, for example, for each of two or more organizations and for each of two or more items, an average value of the satisfaction level information included in the response information and an average value of the expectation level information included in the response information, and acquires an item score for each item using the two average values.

The item score acquiring unit 131 may apply satisfaction level information and expectation level information to the individual score table and acquire an item score for each item, for example. The item score acquiring unit 131 may apply the result of statistical processing performed on satisfaction level information and the result of statistical processing performed on expectation level information to the individual score table and acquire an item score for each item, for example. The item score acquiring unit 131 may apply an average value of satisfaction level information and an average value of expectation level information to the individual score table and acquire an item score for each item, for example. The item score acquiring unit 131 may apply a weighted average value of satisfaction level information and a weighted average value of expectation level information to the individual score table and acquire an item score for each item, for example. Note that the weighted average value is a weighted average value that is based on the attribute values of the members.

The item score acquiring unit 131 may calculate an item score for each item, using a function that is an increasing function that has an average value of satisfaction level information as a parameter, and is a decreasing function that has an average value of expectation level information as a parameter.

The above description describes processing through which the item score acquiring unit 131 calculates a so-called absolute item score. An absolute item score is an item score that does not depend on an organization identifier such as an industry type, and is acquired typically only from response information corresponding to the organization identifier of one organization.

However, the item score acquiring unit 131 may calculates a so-called relative item score. That is to say, the item score acquiring unit 131 acquires, for example, an item score according to an organization attribute value. In such a case, the item score acquiring unit 131 calculates, for example, an absolute item score of each item of the organization. Thereafter, the item score acquiring unit 131 calculates, for example, a relative item score, using one or more item scores acquired from response information corresponding to one or more organization identifiers paired with the same organization attribute value (e.g., the same industry type) as the organization attribute value of the organization.

The item score acquiring unit 131 calculates, for example, a deviation value of the absolute item score of the organization, using an item score of an organization identified by one or more organization identifiers paired with the same organization attribute value as that of the organization. Note that the technique for calculating a relative item score, which is a deviation value of one absolute item score, using multiple absolute item scores, is well known.

Furthermore, the item score acquiring unit 131 may calculate an average value of two or more absolute item scores acquired from response information corresponding to one or more organization identifiers paired with the same organization attribute value as that of the organization, and acquire a relative item score, using a difference between the average value and the absolute item score of the organization, for example. Note that this relative item score may be a difference itself between an average value of item scores and the absolute item score of the organization, or may be a value calculated by substituting this difference in the operation expression as a parameter.

That is to say, there are various conceivable methods for calculating a relative item score of one organization, using absolute item scores of multiple organizations corresponding to the same organization attribute value. The same organization attribute value means that one or more organization attribute values are the same. The item score acquiring unit 131 may, for example, calculate a relative item score of a company of interest among multiple companies of the same industry type, or may calculate a relative item score of a company of interest among multiple companies within a category of the same industry type and with a similar size, for each item.

The overall score acquiring unit 132 acquires an overall score for two or more pieces of organization response information, using two or more item scores. The overall score is an overall score of an organization. Typically, the higher each of the two or more item scores is, the higher the overall score acquired by the overall score acquiring unit 132 is.

The overall score acquiring unit 132 acquires an attribute value-considering overall score that is a score of an organization identified by an organization identifier that is included in an output instruction, and is a score of the organization corresponding to one or more organization attribute values paired with the organization identifier, using multiple pieces of organization response information.

That is to say, the overall score acquiring unit 132 may, for example, acquire an attribute value-considering overall score, which is a relative overall score of one organization, among multiple organizations matching the condition configured using one or more organization attribute values. For example, the overall score acquiring unit 132 may acquire an attribute value-considering overall score of “laboratory+engineering sector” of A company, which is a manufacturer, from the response information regarding employees belonging to a laboratory or an engineering sector of a specific organization (e.g., A company), among multiple organizations with the type identifier “manufacturer” and the sector identifier “laboratory or engineering sector”. In such a case, the condition is “(industry type identifier=manufacturer) AND (sector identifier=laboratory OR engineering sector)”. The overall score acquiring unit 132 acquires, for example, an absolute overall score, using two or more absolute item scores.

Furthermore, the overall score acquiring unit 132 acquires, for example, an attribute value-considering overall score, which is a relative overall score, using two or more relative item scores.

The overall score acquiring unit 132 preferably acquires an overall score, using a score adjusting function in the following manner. The score adjusting function is a function of adjusting a score using correlation information regarding the degree of correlation between the satisfaction level information and the expectation level information. In this example, it is preferable to set the score adjusting function such that the higher the correlation between the satisfaction level information and the expectation level information is, the higher the overall score is.

The overall score acquiring unit 132 acquires, for example, for each organization, a tentative overall score that is a tentative overall score of each organization, using two or more item scores. Thereafter, the overall score acquiring unit 132 acquires, for each organization, correlation information regarding the degree of correlation between the satisfaction level information and the expectation level information for each of two or more items, and acquires an overall score from the acquired tentative overall score, using the correlation information, so that that the higher the degree of correlation is, the higher the score is. Correlation information may be a correlation value between a set of pieces of satisfaction level information and a set of pieces of expectation level information for two or more items, a value calculated using an operation expression that is an increasing function having, as a parameter, the number of items in which a difference between satisfaction level information for each of the two or more items and expectation level information for each of the two or more items is less than or equal to a threshold value, or a value calculated using an operation expression that is a decreasing function having, as a parameter, the number of items in which a difference between satisfaction level information for each of the two or more items and expectation level information for each of the two or more items is less than or equal to a threshold value, and the satisfaction level information is smaller. That is to say, there is no limitation on the algorithm for acquiring correlation information.

The overall score acquiring unit 132 preferably acquires an overall score, using both item scores of overall items and item scores of individual items while making the weights of item scores of overall items greater than those of item scores of the individual items. Also in this case, the overall score acquiring unit 132 can acquire an absolute overall score, using an absolute item score. Also, the overall score acquiring unit 132 can acquire an attribute value-considering overall score, using a relative item score.

The overall score acquiring unit 132 may, for example, calculate an overall score, using the equation “overall score=α×statistical score of item scores of overall items+β×statistical score of item scores of individual items”. In this example, it is preferable that (α>β). That is to say, the overall score acquiring unit 132 preferably acquires an overall score while making the weights of item scores of overall items greater than those of item scores of the individual items. For example, “α=0.7, β=0.3”. The statistical score of item scores of overall items is, for example, an average value, a weighted average value, or the like of item scores of overall items. The statistical score of item scores of individual items is, for example, an average value, a weighted average value, or the like of item scores of individual items.

The overall score acquiring unit 132 may, for example, calculate a tentative overall score, using the equation “tentative overall score=α×statistical score of item scores of overall items+β×statistical score of item scores of individual items”, perform score adjustment using the above-described score adjusting function, and calculate an overall score. Furthermore, the overall score acquiring unit 132 may, for example, calculate a deviation value of an overall score of each organization, using overall scores of multiple organizations, and take the deviation value as an ultimate overall score.

The overall score acquiring unit 132 acquires an overall score and an organization attribute value paired with an organization identifier contained in an output instruction, and acquires an attribute value-considering overall score, which is a score of an organization according to the organization attribute value, using the overall score and the organization attribute value. The attribute value-considering overall score may be regarded as a relative overall score that depends on an organization attribute value. The attribute value-considering overall score may also be referred to as a relative engagement score. Note that an organization attribute value in such a case is one or more organization attribute values.

The overall score acquiring unit 132 acquires, for example, an attribute value-considering overall score, which is a score of an organization identified by an organization identifier contained in an output instruction, and is a score of the organization according to an organization attribute value paired with the organization identifier, using multiple pieces of organization response information.

The overall score acquiring unit 132 acquires an overall score and an organization attribute value paired with an organization identifier contained in an output instruction, and acquires an attribute value-considering overall score, using the overall score and the organization attribute value. The overall score in this example is an absolute overall score, and the attribute value-considering overall score is a relative overall score.

The overall score acquiring unit 132 acquires an attribute value-considering overall score, using the two or more relative item scores acquired by the item score acquiring unit 131. Typically, the higher the relative item score is, the higher the attribute value-considering overall score acquired by the overall score acquiring unit 132 is. The overall score acquiring unit 132 acquires, for example, an attribute value-considering overall score, using an increasing function (e.g., an average value, a weighted average value, a sum, etc.) having, as a parameter, two or more relative item scores acquired by the item score acquiring unit 131. For example, a correspondence table of sets of two or more relative item scores and attribute value-considering overall scores is stored in the storage unit 11, and, referring to the correspondence table, the overall score acquiring unit 132 acquires an attribute value-considering overall score corresponding to the two or more relative item scores acquired by the item score acquiring unit 131, from the correspondence table.

The multiple score acquiring part 1321 acquires an organization attribute value paired with the organization identifier included in an output instruction, and acquires two or more overall scores paired with the organization attribute value from the organization information storage unit 114.

The attribute value-considering overall score acquiring part 1322 acquires an attribute value-considering overall score, using the two or more overall scores acquired by the multiple score acquiring part 1321.

The attribute value-considering overall score acquiring part 1322 acquires, for example, an attribute value-considering overall score that is a relative score of the overall score paired with the organization identifier included in the output instruction, of the two or more overall score acquired by the multiple score acquiring part 1321.

The attribute value-considering overall score acquiring part 1322 acquires, for example, an attribute value-considering overall score that is a deviation value of the overall score paired with the organization identifier included in the output instruction, of the two or more overall score acquired by the multiple score acquiring part 1321.

The attribute value-considering overall score acquiring part 1322 acquires, for example, an average value of the two or more overall scores acquired by the multiple score acquiring part 1321, and acquires an attribute value-considering overall score, using a difference between the average value and the overall score paired with the organization identifier included in the output instruction. The attribute value-considering overall score may be the difference, or a score calculated using an operation expression that has the difference as a parameter.

The output unit 14 outputs various kinds of information. Examples of various kinds of information include an attribute value-considering overall score. Examples of various kinds of information include a set of pairs of pieces of information each consisting of an item identifier and an item score. Note that the item score may be an absolute item score or a relative item score. Examples of various kinds of information include an absolute overall score. Here, “output” typically means transmission to an external apparatus such as the terminal apparatus 2. However, “output” may be regarded as a concept that includes displaying on a display device, projection with a projector, printing with a printer, sound output, accumulation on a recording medium, delivery of processing results to another processing apparatus or another program, and so on.

The item score output unit 141 outputs one or more item scores. The item score output unit 141 typically outputs, in association with an item identifier, an item score of an item identified by the item identifier. Note that the item score may be the above-described absolute item score or a relative item score.

The item score output unit 141 outputs an item score that is paired with an organization identifier that is included in an output instruction, in association with an item identifier, for example. It is preferable that the item score output unit 141 outputs one or more item scores in association with an organization identifier. It is also preferable that the item score output unit 141 outputs item scores such that an item score of an overall item and an item score of an individual item are visually distinguishable from each other.

The overall score output unit 142 outputs an attribute value-considering overall score. It is preferable that the overall score output unit 142 outputs an attribute value-considering overall score in association with an organization identifier.

The overall score output unit 142 may output an absolute overall score. It is preferable that the overall score output unit 142 outputs an absolute overall score in association with an organization identifier.

The terminal storage unit 21 included in the terminal apparatus 2 stores various kinds of information. Examples of various kinds of information include an organization identifier that identifies the organization of a user. Examples of various kinds of information include information that has been received by the terminal receiving unit 25. Note that an organization identifier may be regarded as information that identifies a user.

The terminal accepting unit 22 accepts various instructions, information, and so on. Here, “acceptance” is a concept that encompasses accepting information input from an input device such as a keyboard, a mouse, or a touch panel, receiving information transmitted via a wired or wireless communication network, accepting information read from a recording medium such as an optical disk, a magnetic disk, a semiconductor memory, or the like. Examples of various kinds of instructions and information include an output instruction, organization response information, questionnaire response information, organization information that includes an organization identifier and an organization attribute value, and so on.

The terminal processing unit 23 performs various kinds of processing. Examples of various kinds of processing include processing that is performed to form data that is to be displayed, using information that has been received by the terminal receiving unit 25. Examples of various kinds of processing include processing that is performed to form an instruction or the like that is to be transmitted, from an instruction or the like that has been accepted by the terminal accepting unit 22.

The terminal transmitting unit 24 transmits various instructions, information, and so on to the information processing apparatus 1. Examples of various instructions, information, and so on include an instruction formed by the terminal processing unit 23, an instruction, information, or the like that has been accepted by the terminal accepting unit 22.

The terminal receiving unit 25 receives various kinds of information from the information processing apparatus 1. Examples of various kinds of information include an attribute value-considering overall score, an absolute or relative item score, and an absolute overall score.

The terminal output unit 26 acquires various kinds of information. Examples of various kinds of information include information that has been accepted by the terminal accepting unit 22, information that has been received by the terminal receiving unit 25, and information that has been formed by the terminal processing unit 23. Examples of various kinds of information include an attribute value-considering overall score, an absolute or relative item score, and an overall score.

It is preferable that the storage unit 11, the item information storage unit 111, the organization response information storage unit 112, the individual score table storage unit 113, the organization information storage unit 114, and the terminal storage unit 21 are realized using a non-volatile recording medium, but they may be realized using a volatile recording medium. There is no limitation on the process in which information is stored in the storage unit 11 and so on. For example, information may be stored in the storage unit 11 or the like via a recording medium, or information transmitted via a communication line or the like may be stored in the storage unit 11 or the like, or information input via an input device may be stored in the storage unit 11 or the like.

The accepting unit 12, the output instruction accepting unit 121, and the terminal receiving unit 25 typically are realized using a wireless or wired communication means, but they may be realized using a means for receiving broadcast.

The processing unit 13, the item score acquiring unit 131, the overall score acquiring unit 132, the multiple score acquiring part 1321, the attribute value-considering overall score acquiring part 1322, and the terminal processing unit 23 may typically be realized using an MPU, a memory, or the like. The processing procedures performed by the processing unit 13 and so on typically are realized using software, and the software is recorded on a recording medium such as a ROM. However, such processing procedures may be realized using hardware (a dedicated circuit).

The output unit 14, the item score output unit 141, the overall score output unit 142, and the terminal transmitting unit 24 typically are realized using a wireless or wired communication means, but they may be realized using a broadcast means.

The terminal accepting unit 22 may be realized using a device driver for the input means such as a touch panel or a keyboard, or control software or the like for controlling the menu screen.

The terminal output unit 26 may be regarded as including or not including an output device such as a display or a speaker. The terminal output unit 26 may be realized using the driver software of the output device, the driver software of the output device and the output device, or the like.

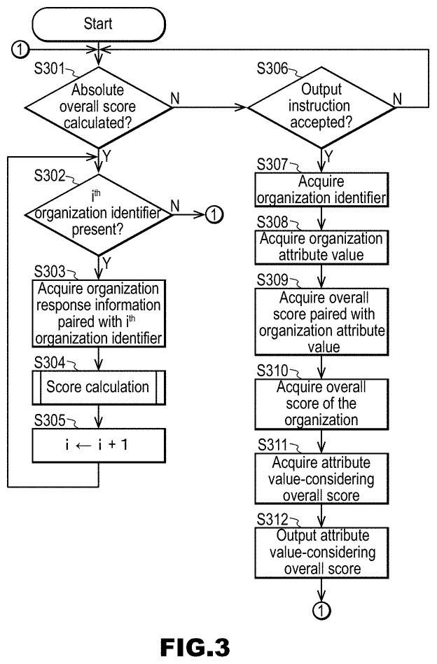

Next, operations that are performed by the information system A will be described. First, examples of operations of the information processing apparatus 1 will be described with reference to the flowchart shown in FIG. 3. It is assumed that the organization response information storage unit 112 stores organization response information regarding multiple organizations. It is also assumed that the individual score table storage unit 113 stores an individual score table.

(Step S301) The processing unit 13 determines whether or not it is the time to calculate an absolute overall score. If it is the time to calculate an absolute overall score, processing proceeds to step S302, and if it is not the time to calculate an absolute overall score, processing proceeds to step S312. Note that the time to calculate an absolute overall score is, for example, when an instruction is input from a user, an administrator, or the like, when a predetermined time is reached, when two or more pieces of organization response information have been received and have been accumulated in the organization response information storage unit 112, and so on.

(Step S302) The processing unit 13 determines whether or not the i^{th} organization identifier is present in the two or more pieces of organization response information and so on in the organization response information storage unit 112. If the i^{th} organization identifier is present, processing proceeds to step S303, and if the i^{th} organization identifier is not present, processing returns to step S301.

(Step S303) The processing unit 13 acquires organization response information that is paired with the i^{th} organization identifier, from the organization response information storage unit 112.

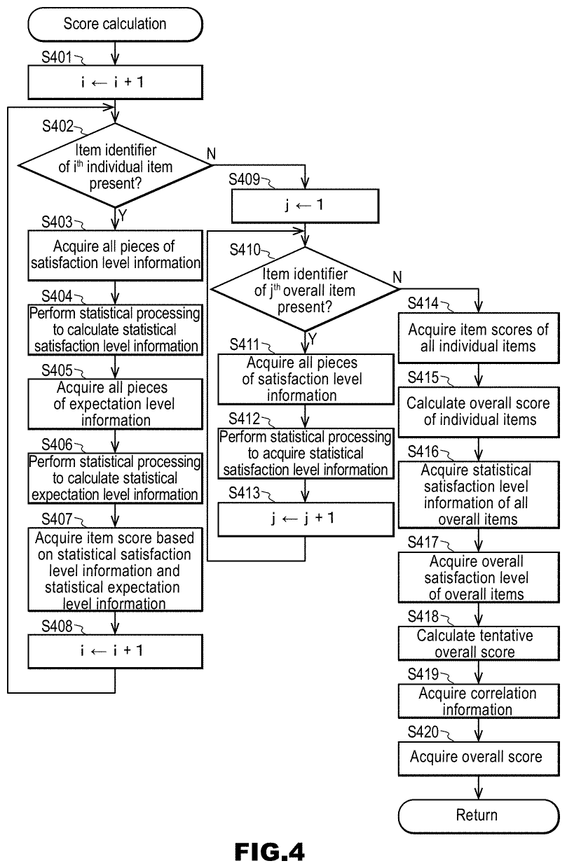

(Step S304) The processing unit 13 calculates various scores corresponding to the i^{th} organization identifier, using the organization response information acquired in step S303. Note that the various scores include an absolute overall score. Note that calculation of a score means the same as acquisition of a score. Such score calculation processing will be described with reference to the flowchart shown in FIG. 4. It is also assumed that the calculated absolute overall score is accumulated in the organization information storage unit 114 in association with the organization identifier.

(Step S305) The processing unit 13 increments a counter i by 1. Processing returns to step S302.

(Step S306) The output instruction accepting unit 121 determines whether or not an output instruction has been accepted. If an output instruction has been accepted, processing proceeds to step S307, and if an output instruction has not been accepted, processing returns to step S301. Note that acceptance of an output instruction is, for example, reception of an output instruction from the terminal apparatus 2.

(Step S307) The multiple score acquiring part 1321 acquires an organization identifier that is included in the output instruction accepted in step S306.

(Step S308) The multiple score acquiring part 1321 acquires an organization attribute value that is paired with the organization identifier acquired in step S307, from the organization information storage unit 114. Note that the multiple score acquiring part 1321 may acquire organization attribute values or one or more organization attributes of a type specified by the accepted output instruction, from the organization information storage unit 114. In such a case, the output instruction includes information that specifies the type of the organization attribute (for example, “industry type”, “industry type, size”, or the like).

(Step S309) The multiple score acquiring part 1321 acquires one or more overall scores that are paired with the organization attribute value acquired in step S308, from the organization information storage unit 114.

(Step S310) The attribute value-considering overall score acquiring part 1322 acquires an overall score that is paired with the organization identifier acquired in step S307.

(Step S311) The attribute value-considering overall score acquiring part 1322 acquires an attribute value-considering overall score, which is a relative overall score, of the organization identified by the organization identifier acquired in step S307, using the one or more overall scores acquired instep S309 and the overall score acquired in step S310.

(Step S312) The overall score output unit 142 outputs the attribute value-considering overall score acquired in step S311. Note that the output here is, for example, transmission to the terminal apparatus 2 that has transmitted the output instruction.

Note that, in step S312, the overall score output unit 142 may also output the absolute overall score acquired in step S310. The item score output unit 141 may also output the item score of each item paired with the organization identifier acquired in step S307.

In addition, there is no limitation on when the attribute value-considering overall score is calculated. The overall score output unit 142 may calculate an attribute value-considering overall score in advance and accumulate it in the organization information storage unit 114. In such a case, the overall score acquiring unit 132 simply reads out the attribute value-considering overall score stored in the organization information storage unit 114.

In addition, in the flowchart shown in FIG. 3, there is no limitation on the route through which organization response information is accumulated in the organization response information storage unit 112.

Furthermore, in the flowchart shown in FIG. 3, processing is terminated when power is turned off or an interruption is made to terminate the processing.

Next, an example of the score calculation processing shown in step S304 will be described with reference to the flowchart shown in FIG. 4.

(Step S401) The item score acquiring unit 131 substitutes 1 for the counter i.

(Step S402) The item score acquiring unit 131 determines whether or not the item identifier of the i^{th} individual item is present in the organization response information acquired in step S303. If the item identifier of the i^{th} individual item is present, processing proceeds to step S403, and otherwise processing proceeds to step S409.

(Step S403) The item score acquiring unit 131 acquires satisfaction level information regarding all the members paired with the item identifier of the i^{th} individual item of the organization response information acquired in step S307.

(Step S404) The item score acquiring unit 131 performs statistical processing on the satisfaction level information acquired in step S403, to calculate statistical satisfaction level information. Here, note that the item score acquiring unit 131 calculates, for example, statistical satisfaction level information that is an average value of the satisfaction level information acquired in step S403. Thereafter, the item score acquiring unit 131 accumulates the calculated satisfaction level information in the storage unit 11 or a buffer (not shown) in pair with the item identifier of the i^{th} individual item.

(Step S405) The item score acquiring unit 131 acquires expectation level information regarding all the members paired with the item identifier of the i^{th} individual item of the organization response information acquired in step S307.

(Step S406) The item score acquiring unit 131 performs statistical processing on the expectation level information acquired in step S405, to calculate statistical expectation level information. Here, note that the item score acquiring unit 131 calculates, for example, statistical expectation level information that is an average value of the expectation level information acquired in step S403. Thereafter, the item score acquiring unit 131 accumulates the calculated expectation level information in the storage unit 11 or a buffer (not shown) in pair with the item identifier of the i^{th} individual item.

(Step S407) The item score acquiring unit 131 acquires the item score of the i^{th} individual item of the organization of interest, using the statistical satisfaction level information and the statistical expectation level information. Note that the item score acquiring unit 131 applies the statistical satisfaction level information and the statistical expectation level information to the individual score table in the individual score table storage unit 113 to acquire the item score of the i^{th} individual item. Thereafter, the item score acquiring unit 131 accumulates the acquired item score in the storage unit 11 or a buffer (not shown) in pair with the item identifier of the i^{th} individual item.

(Step S408) The item score acquiring unit 131 increments the counter i by 1. Processing returns to step S402.

(Step S409) The item score acquiring unit 131 substitutes 1 for a counter j.

(Step S410) The item score acquiring unit 131 determines whether or not the item identifier of the j^{th} overall item is present in the organization response information acquired in step S307. If the item identifier of the j^{th} overall item is present, processing proceeds to step S411, and otherwise processing proceeds to step S414.

(Step S411) The item score acquiring unit 131 acquires satisfaction level information regarding all the members paired with the item identifier of the j^{th} overall item of the organization response information acquired in step S307.

(Step S412) The item score acquiring unit 131 performs statistical processing on the satisfaction level information acquired in step S411, to calculate statistical satisfaction level information. Here, note that the item score acquiring unit 131 calculates, for example, statistical satisfaction level information that is an average value of the satisfaction level information acquired in step S411. Thereafter, the item score acquiring unit 131 accumulates the calculated satisfaction level information in the storage unit 11 or a buffer (not shown) in pair with the item identifier of the j^{th} overall item.

(Step S413) The item score acquiring unit 131 increments the counter j by 1. Processing returns to step S410.

(Step S414) The overall score acquiring unit 132 acquires the item score of all the individual items from the storage unit 11 or a buffer (not shown). Note that the item scores of the individual items are the scores acquired in step S407.

(Step S415) The overall score acquiring unit 132 acquires an overall score of the individual item from all the item scores acquired in step S414. For example, the overall score acquiring unit 132 calculates an average value of all the item scores acquired in step S414, and acquires the average value as an overall score of the individual item.

(Step S416) The overall score acquiring unit 132 acquires the statistical satisfaction level information regarding all items of the overall items from the storage unit 11 or a buffer (not shown).

(Step S417) The overall score acquiring unit 132 performs statistical processing on the satisfaction level information regarding all the items acquired in step S416, to calculate statistical satisfaction level information regarding the overall item. For example, the overall score acquiring unit 132 calculates an average value of the statistical satisfaction level information regarding all the items acquired in step S416, and acquires the average value as the statistical satisfaction level information regarding the overall item.

(Step S418) The overall score acquiring unit 132 calculates a tentative overall score from the overall score of the individual item acquired in step S415 and the statistical satisfaction level information regarding the overall item acquired in step S417. Note that the overall score acquiring unit 132 calculates a tentative overall score, using the equation “tentative overall score=α×statistical satisfaction level information regarding overall items+β×overall scores of individual items”.

(Step S419) The overall score acquiring unit 132 acquires correlation information regarding correlation between the set of pieces of satisfaction level information and the set of pieces of expectation level information from the pieces of satisfaction level information regarding all the individual items and the set of pieces of expectation level information regarding all the individual items.

(Step S420) The overall score acquiring unit 132 adjusts the tentative overall score acquired in step S418, using the correlation information acquired in step S419, to acquire an overall score. Processing returns to higher level processing. Note that the overall score acquiring unit 132 acquires an overall score so that the higher the degree of correlation indicated by the correlation information is, the higher the overall score is.

The examples of operations in FIGS. 3 and 4 show a case in which, after an absolute overall score is calculated for each organization, an attribute value-considering overall score is acquired, using one or more absolute overall scores of other one or more organizations corresponding to the same organization identifier as the organization identifier of the organization of interest.

However, it is possible that a relative item score of each item of the organization of interest is calculated from the item score of each item of each organization, and an attribute value-considering overall score that is a relative overall score is acquired using the two or more relative item scores.

That is to say, the attribute value-considering overall score need only be a value that indicates a relative overall score in multiple organizations corresponding to the same organization attribute value as the organization attribute value of the organization of interest, and there is no limitation on the process through which the value is calculated.

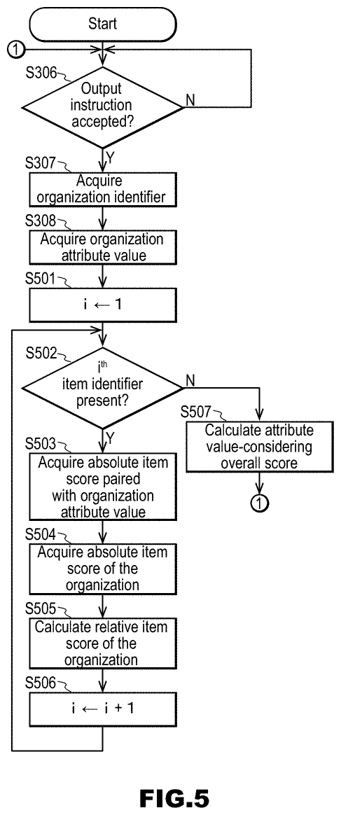

Processing through which an attribute value-considering overall score is acquired after a relative item score is calculated will be described with reference to the flowchart shown in FIG. 5. Regarding the flowchart in FIG. 5, descriptions of the same processing as in the flowchart in FIG. 3 will be omitted. Also, in the flowchart in FIG. 5, it is assumed that an absolute item score has been calculated for each organization, and is stored in the storage unit 11 in association with an organization identifier and an item identifier.

(Step S501) The item score acquiring unit 131 substitutes 1 for the counter i.

(Step S502) The item score acquiring unit 131 determines whether or not the i^{th} item identifier is present. If the i^{th} item identifier is present, processing proceeds to step S503, and if the i^{th} item identifier is not present, processing proceeds to step S507.

(Step S503) The item score acquiring unit 131 acquires one or more absolute item scores that are one or more absolute item scores paired with the organization attribute value acquired in step S308 and correspond to the i^{th} item identifier.

(Step S504) The item score acquiring unit 131 acquires an absolute item score corresponding to the i^{th} item identifier, of the organization identified by the organization identifier acquired in step S307.

(Step S505) The item score acquiring unit 131 calculates a relative item score of the organization, using the one or more absolute item scores acquired in step S503 and the absolute item score acquired in step S504. It is preferable that the item score acquiring unit 131 accumulates the calculated relative item score in the storage unit 11 in association with the organization identifier of the organization and the i^{th} item identifier.

(Step S506) The item score acquiring unit 131 increments the counter i by 1. Processing returns to step S502.

(Step S507) The overall score acquiring unit 132 acquires an attribute value-considering overall score, using the two or more relative item scores calculated in step S505. Processing returns to step S306.

Next, operations that are performed by the terminal apparatus 2 will be described. The terminal accepting unit 22 of the terminal apparatus 2 accepts various instructions, information, and so on. Next, the terminal processing unit 23 forms an instruction or the like that is to be transmitted, from an instruction or the like that has been accepted by the terminal accepting unit 22. The terminal transmitting unit 24 transmits an instruction or the like formed by the terminal processing unit 23 to the information processing apparatus 1. Upon an instruction or the like being transmitted, the terminal receiving unit 25 receives information from the information processing apparatus 1. Next, the terminal processing unit 23 forms data that is to be displayed, using information that has been received by the terminal receiving unit 25. Next, the terminal output unit 26 outputs the information formed by the terminal processing unit 23.

The following describes specific operations that are performed by the information system A according to the present embodiment. A conceptual diagram for the information system A is FIG. 1.

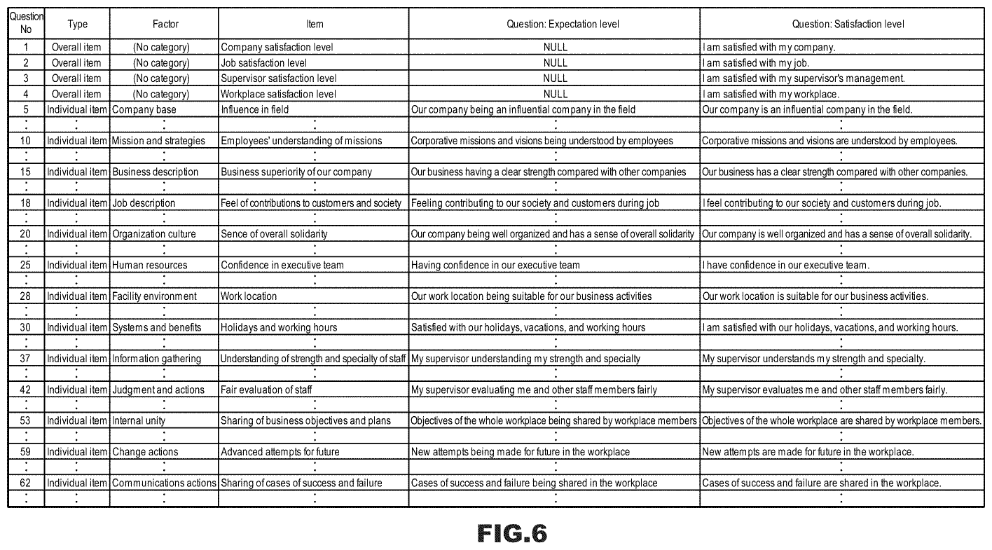

Now, it is assumed that the item information storage unit 111 stores the item information management table shown in FIG. 6. The item information management table is a table for managing many pieces of item information showing questionnaire items for the members (employees in this example) of an organization (a company in this example). The item information in this example has “question No”, “type”, “factor”, “item”, “question: expectation level”, and “question: satisfaction level”. “Question No” is an ID that identifies a question, and is an example of an item identifier. “Type” is information indicating the type of item, and, in this example, may be either an overall item or an individual item. “Factor” is a middle concept of an item, and may also be referred to as a target. “Item” is information indicating the content of an item. Note that “item” may be regarded as an item identifier. “Question: expectation level” is a question for acquiring expectation level information. “Question: satisfaction level” is a question for acquiring satisfaction level information.

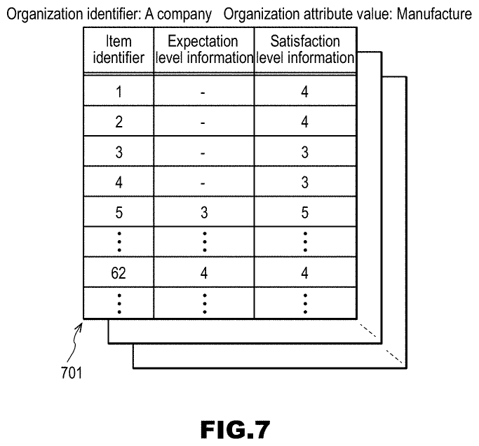

Also, for example, organization response information with the structure as shown in FIG. 7 is stored in the organization response information storage unit 112. The organization response information storage unit 112 stores two or more pieces of organization response information. FIG. 7 shows organization response information regarding an organization that is identified by the organization identifier “A company”. 701 indicates member response information regarding one employee of the organization identified by the organization identifier “A company”. Organization response information regarding the organization identified by the organization identifier “A company” includes member response information regarding two or more employees. Member response information includes many (63 or more in this example) records that each include “item identifier”, “expectation level information”, and “satisfaction level information”. Note that the records of the items with the item identifiers 1 to 4 are records of an overall item, and do not include expectation level information. The expectation level information and the satisfaction level information included in the member response information 701 are information acquired from responses of an employee to “question: expectation level” and “question: satisfaction level” of the item information management table shown in FIG. 6. Such a response in this example is a response indicated by one of the naturals numbers 1 to 5. Also, in this example, if the expectation level information corresponding to “question: expectation level” indicates 1, the expectation level is lowest, and, if the expectation level information indicates 5, the expectation level is highest. If the satisfaction level information corresponding to “question: satisfaction level” indicates 1, the satisfaction level is lowest, and, if the satisfaction level information indicates 5, the satisfaction level is highest. Also, it is assumed that the organization attribute value of the industry type of the organization identified by the organization identifier “A company” is “manufacturer”. Note that the industry type is an example of an organization attribute. It is assumed that the organization response information storage unit 112 stores multiple pieces of organization response information regarding organizations corresponding to the organization attribute value “manufacturer”.

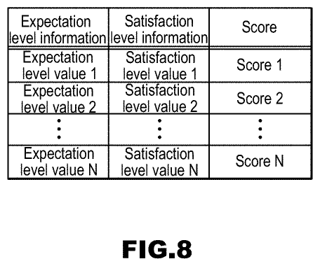

The individual score table storage unit 113 stores the individual score table shown in FIG. 8. The individual score table is for managing two or more records that each include “expectation level information”, “satisfaction level information”, and “score”. “Expectation level information” is, for example, an average value of the expectation level information. “Expectation level information” may be, for example, information indicating the range of an average value of the expectation level information. Expectation level value 1”, “expectation level value 2”, . . . , and “expectation level value N”, which are attribute values of “expectation level information”, are information indicating specific values or ranges. “Satisfaction level information” is, for example, an average value of the satisfaction level information. “Satisfaction level information” may be, for example, information indicating the range of an average value of the satisfaction level information. “Satisfaction level value 1”, “satisfaction level value 2”, . . . , and “satisfaction level value N”, which are attribute values of “satisfaction level information”, are information indicating specific values or ranges. “Score” in this example is information indicating an item score. “Score 1”, “score 2”, . . . , and “score N”, which are attribute values of “score”, are specific values.

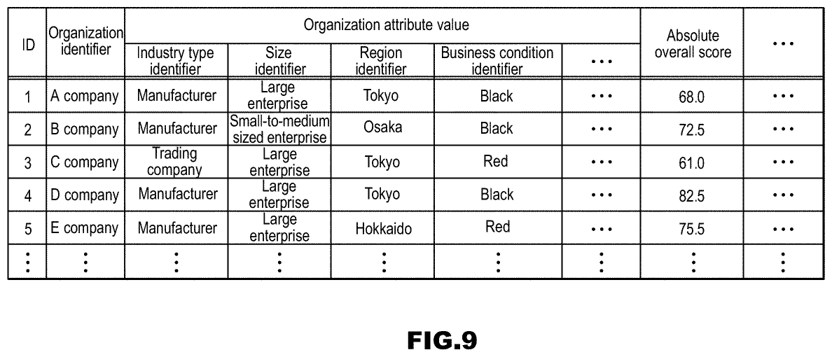

Furthermore, the organization information storage unit 114 stores the organization information management table shown in FIG. 9. The organization information management table is a table for managing organization information. The organization information management table includes two or more records that each include “ID”, “organization identifier”, “organization attribute value”, “overall score”, and so on. “Organization attribute value” in this example includes “industry type identifier”, “size identifier”, “region identifier”, “business conditions identifier”, and so on. “Industry type identifier” is information that identifies an industry type, and indicates a manufacturer, trading company, bank, or the like in this example. “Size identifier” is information that identifies a size of an organization, such as large enterprise, small-to-medium sized enterprise, micro enterprise, self-employed, or the like. “Region identifier” is information that identifies a location of a home office of an organization (company, etc.), such as any one of the prefectures. “Business conditions identifier” is information that identifies a business condition, such as black or red.

In such a situation, it is assumed that the administrator of the information processing apparatus 1 has input an instruction to calculate scores and so on. As a result, the accepting unit 12 accepts an instruction to calculate scores and so on. Next, the processing unit 13 determines that it is the time to calculate scores and so on. Note that the instruction to calculate scores and so on in this example is an instruction to calculate an absolute item score and an absolute overall score of each organization.

Next, the processing unit 13 calculates the item score of each item and an absolute overall score, using the pieces of organization response information respectively paired with the organization identifier, such as “A company”. Hereinafter, calculation of an absolute item score and an overall score in the case of “A company” will be described as an example.

That is to say, the item score acquiring unit 131 acquires member response information that is paired with the organization identifier “A company”. Thereafter, the item score acquiring unit 131 acquires satisfaction level information regarding all the members for each individual item from the acquired member response information. Next, the item score acquiring unit 131 acquires the average value of the pieces of satisfaction level information thus acquired, as statistical satisfaction level information regarding each individual item. Also, the item score acquiring unit 131 acquires the average value of the pieces of expectation level information thus acquired, as statistical expectation level information regarding each individual item. Next, the item score acquiring unit 131 applies the statistical satisfaction level information and the statistical expectation level information to the individual score table shown in FIG. 8 to acquire the absolute item score of each individual item. Thereafter, the item score acquiring unit 131 accumulates the acquired item score in a buffer in association with the item identifier of each individual item.

Next, the item score acquiring unit 131 acquires satisfaction level information regarding all the members corresponding to the item identifier of each overall item. Thereafter, the item score acquiring unit 131 calculates, for each overall item, the average value of the pieces of satisfaction level information thus acquired, and acquires the average value as statistical satisfaction level information. Next, the item score acquiring unit 131 accumulates the statistical satisfaction level information regarding each overall item in the buffer, in pair with the item identifier of the overall item.

Next, the overall score acquiring unit 132 acquires the overall scores of all the item scores of all the individual items. Next, the overall score acquiring unit 132 acquires the overall score of all the item scores of all the individual items.

Next, the overall score acquiring unit 132 performs statistical processing on the satisfaction level information regarding all the items, to calculate statistical satisfaction level information regarding the overall item. In this example, the overall score acquiring unit 132 acquires an average value of the pieces of statistical satisfaction level information regarding all the items as statistical satisfaction level information regarding the overall item.

Next, the overall score acquiring unit 132 calculates a tentative overall score, using the equation “tentative overall score=0.7×statistical satisfaction level information regarding overall items+0.3×overall scores of individual items”.

Next, the overall score acquiring unit 132 acquires correlation information regarding correlation of the set of pieces of satisfaction level information and the set of pieces of expectation level information from the pieces of satisfaction level information of all the individual items and the set of pieces of expectation level information of all the individual items.

Next, the overall score acquiring unit 132 makes an adjustment to the acquired tentative overall score, using the acquired correlation information. The overall score acquiring unit 132 acquires a deviation value, using the values obtained by adjusting the tentative overall scores of other companies, as well. Such a deviation value is an overall score. Here, it is assumed that the overall score acquiring unit 132 performs calculation and obtains the overall score “68.0” of the organization identified by the organization identifier “A company”. The overall score acquiring unit 132 accumulates the overall score “68.0” in the organization information management table shown in FIG. 9, in association with the organization identifier “A company”. Note that the calculation through which values are obtained by adjusting the tentative overall scores of other companies is performed in the same manner as the calculation of value of “A company”.

The above processing is performed on other pieces of organization response information as well. It is assumed that the absolute item scores of the individual items and the absolute overall score are thereafter calculated for all the pieces of organization response information (organizations), and are accumulated in the organization information management table shown in FIG. 9. In FIG. 9, although the item scores of the individual items are not shown, the item scores are accumulated in association with the company identifiers and the item identifiers.

In such a situation, it is assumed that a user of “A company” inputs an output instruction to the terminal apparatus 2. Note that an output instruction in this example includes an attribute identifier “industry type, size” that is to be used to acquire an attribute value-considering overall score.

Next, the terminal apparatus 2 accepts the output instruction, and forms an output instruction that includes the organization identifier “A company” and the attribute identifier “industry type, size”. Thereafter, the terminal apparatus 2 transmits such an output instruction to the information processing apparatus 1.

Next, the accepting unit 12 of the information processing apparatus 1 receives the output instruction from the terminal apparatus 2. Next, the multiple score acquiring part 1321 acquires the organization identifier “A company” included in the output instruction. Next, the multiple score acquiring part 1321 acquires the attribute identifier “industry type, size” included in the output instruction. Next, the multiple score acquiring part 1321 acquires the industry type identifier “manufacturer” and the size identifier “large enterprise” that are attribute values corresponding to the attribute identifier “industry type, size” included in the output instruction and are paired with the organization identifier “A company”.

Next, the multiple score acquiring part 1321 acquires two or more absolute overall scores that are paired with the industry type identifier “manufacturer” and the size identifier “large enterprise” from the organization information management table shown in FIG. 9. Note that the multiple score acquiring part 1321 reads out an overall score indicated by “ID=1”, “ID=4”, “ID=5”, or the like from the organization information management table shown in FIG. 9.

Next, the attribute value-considering overall score acquiring part 1322 acquires the absolute overall score “68.0” paired with the acquired organization identifier “A company” from the organization information management table shown in FIG. 9.

Next, the attribute value-considering overall score acquiring part 1322 calculates the attribute value-considering overall score that is the deviation value of the absolute overall score “68.0” of the A company in the two or more acquired absolute overall scores. It is assumed here that the calculated attribute value-considering overall score is “48.5”. Note that the method for calculating a deviation value is a well-known technique and a description thereof is omitted.

Next, the processing unit 13 acquires the absolute item scores of the items paired with the organization identifier “A company” from the storage unit 11 or a buffer (not shown).

Next, the processing unit 13 forms information that is to be output, from the acquired information. Thereafter, the output unit 14 transmits the formed information to the terminal apparatus 2 of the user of “A company”. Note that such information includes the “attribute value-considering overall score “48.5”, the absolute overall score “68.0”, and the absolute item score of each item. It is preferable that the relative item score of each item of “A company” is calculated and is included in the formed information.

Next, the terminal receiving unit 25 of the terminal apparatus 2 receives information from the information processing apparatus 1. Next, the terminal processing unit 23 forms data that is to be displayed, using information that has been received by the terminal receiving unit 25. Next, the terminal output unit 26 outputs the information formed by the terminal processing unit 23.

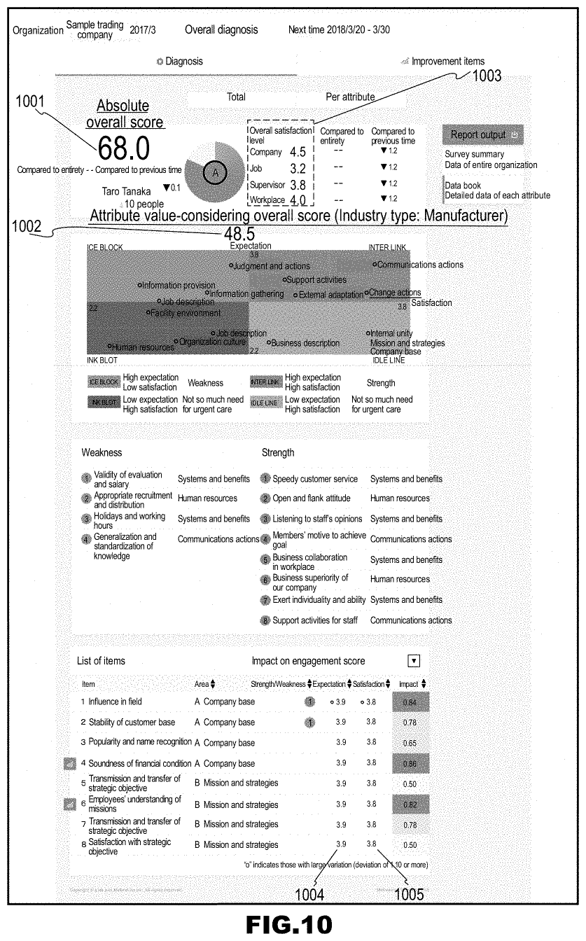

An example of such an output is shown in FIG. 10. 1001 in FIG. 10 indicates the absolute overall score “68.0” of A company. 1002 in FIG. 10 indicates the attribute value-considering overall score “48.5”. 1003 indicates the item scores of the overall items. Here, the overall items are company, supervisor, job, and workplace. In FIG. 10, 1004 indicates an average value of the pieces of expectation level information of the individual items. 1005 indicates an average value of the pieces of satisfaction level information of the individual items.

As described above, according to the present embodiment, it is possible to output an appropriate score of an organization according to one or more organization attribute values. Therefore, it is possible to take appropriate measures for an organization such as a company. Note that such a technology is quite useful in engagement in which employees voluntarily try to exert their own strength to achieve the goals of the organization, and both the employees and the organization grow, for example.

Also, according to the present embodiment, it is possible to acquire one or more engagement scores of: a relative engagement score; and an absolute engagement score, and it is possible to provide an information processing apparatus 1 that can be used as a so-called engagement apparatus.

Furthermore, the processing in the present embodiment may be realized using software. This software may be distributed through software downloading or the like. Also, this software may be recorded on a recording medium such as a CD-ROM and distributed. Note that the same applies to the other embodiments in the present description. The software that realizes the information processing apparatus 1 in the present embodiment is the program described below. That is to say, the program is, for example, a program that enables a computer that can access an organization response information storage unit that stores multiple pieces of organization response information that is information paired with an organization identifier that identifies an organization and with an organization attribute value that indicates an attribute value of the organization, and that each indicate a response to a question for members of the organization, to function as: an output instruction accepting unit that accepts an output instruction that is an instruction to output a score of an organization, and is an instruction that includes an organization identifier; an overall score acquiring unit that acquires an attribute value-considering overall score that is a score of an organization identified by an organization identifier that is included in the output instruction, and is a score of the organization corresponding to an organization attribute value that is paired with the organization identifier, using the multiple pieces of organization response information; and an overall score output unit that outputs the attribute value-considering overall score.

### Embodiment 2

The present embodiment describes an information processing system that includes an information processing apparatus that determines information that is to be presented to a member of an organization or performs processing to determine the layout of information that is to be presented, using organization state information regarding the state of the organization, and outputs the information, to improve the organization. Note that improving an organization means improving the state of the organization. Improving the state of an organization is, for example, improving the satisfaction level of a member with respect to one or more items regarding the organization. Information that is to be presented is, for example, an article, an in-house newsletter, or the like.

Note that organization state information is, for example, the result of processing that is performed by the information processing apparatus 1 described in Embodiment 1. It is preferable that organization state organization is information that is based on a response to a questionnaire directed to two or more members regarding an organization. It is also preferable that organization state information is, for example, information that is based on one or more kinds of information of: an overall statistical processing result, which is the statistical processing result of questionnaire responses from the members of the entire organization (for example, a company); a sector statistical processing result, which is the statistical processing result of questionnaire responses from the members of the sector to which they belong; and questionnaire responses from the members. The organization state information may be information manually input by a user, for example. It is preferable that the information processing apparatus described in the present embodiment is an apparatus for improving the organization in cooperation with the information processing apparatus 1.

The present embodiment also describes an information processing system that includes an information processing apparatus that determines information that is to be presented to members, or the layout of the information, using organization state information that is indicated by an instruction that is made by an administrator or the like (for example, a sector leader) of an organization regarding organization state information (for example, an item for which the score is to be increased) of pieces of organization state information, and outputs the information. Such processing through which information that is to be presented to members is determined is referred to as “manual determination”.

Also, the present embodiment describes an information processing system that includes an information processing apparatus that proposes candidates of organization state information that is to be used, using organization state information, determines information that is to be presented to members, or the layout of the information, using organization state information that is indicated by an instruction that is made by a user from among the proposed pieces of organization state information, and outputs the information. Such processing through which information that is to be presented to members is determined is referred to as “semi-automatic determination”.

The present embodiment also describes an information processing system that includes an information processing apparatus that determines organization state information that is to be used, using organization state information, and determines information that is to be presented to members or the layout thereof, using the determined organization state information, and outputs the information. Such processing through which information that is to be presented to members is determined is referred to as “automatic determination”.

Also, the present embodiment describes an information processing system that includes an information processing apparatus that accumulates browsing records of members regarding information that is output from the terminal apparatuses of members, performs statistical processing on the browsing records, and outputs a statistical processing result.

The present embodiment also describes an information processing system that includes an information processing apparatus that determines information that is to be proposed to members, using browsing records of the members regarding information that is output from the terminal apparatuses of the members.

The present embodiment also describes an information processing system that includes an information processing apparatus that determines information that is to be proposed to members, using browsing records of the members regarding information that is output from the terminal apparatuses of the members, and organization state information.

The present embodiment also describes an information processing system that includes an information processing apparatus that, after a member browses information that is output, acquires and outputs information regarding a change in organization state information corresponding to the output information. Such an information processing system is an information processing system that can perform so-called feedback. It is preferable that the information regarding a change in the organization state information is information regarding a change in the information based on a response to a questionnaire regarding the organization (for example, a change in the score of the corresponding item).

Furthermore, the present embodiment describes an information processing system that includes an information processing apparatus, wherein information that is to be output to the terminal apparatuses of the members is multiple pieces of information that are based on one or more kinds of information of: an overall statistical processing result, which is a statistical processing result of a questionnaire responses from the members of the entire organization; a sector statistical processing result, which is a statistical processing result of the questionnaire responses from the members of the sector to which the members belong, and questionnaire responses from the members.

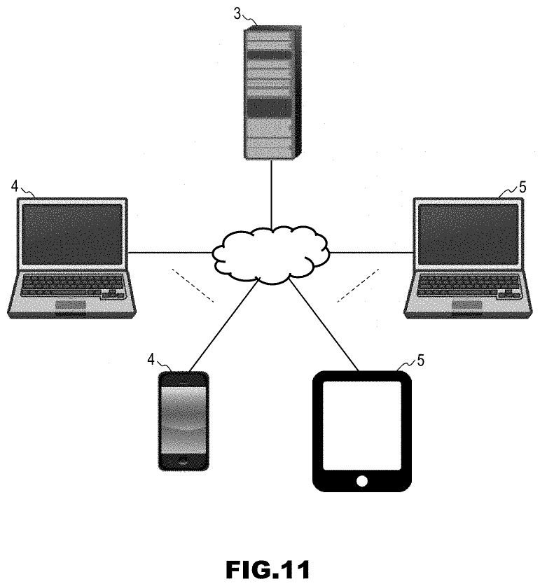

FIG. 11 is a conceptual diagram for an information system B according to the present embodiment. The information system B includes an information processing apparatus 3, one or more terminal apparatuses 4, and one or more management terminals 5. The information processing apparatus 3 in this example is a so-called server apparatus. The information processing apparatus 3 is, for example, a cloud server or an ASP server, and there is no limitation on the type or installation location thereof. The terminal apparatuses 4 and the management terminals 5 are each a mobile terminal such as a smartphone, a tablet device, or a mobile phone, a so-called personal computer, or the like, and there is no limitation on the type thereof. Each terminal apparatus 4 is, for example, an apparatus that is used by a member of an organization. Each management terminal 5 is, for example, an apparatus that is used by an administrator of the organization.

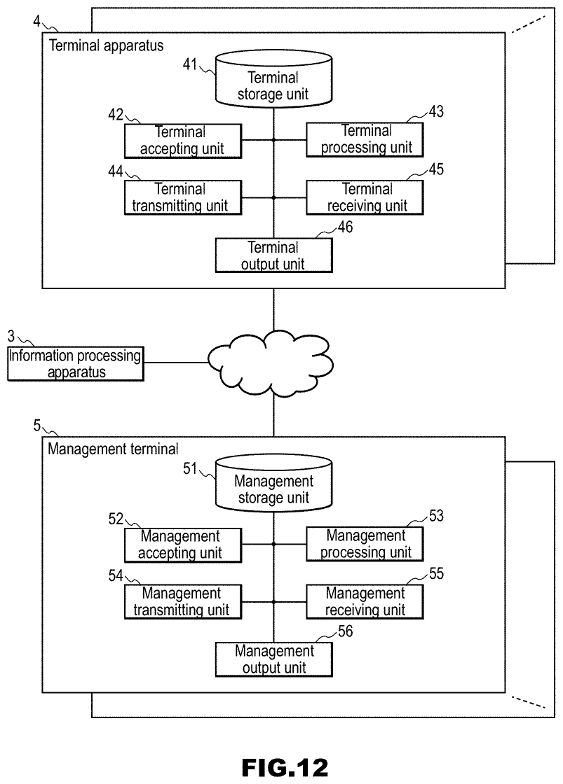

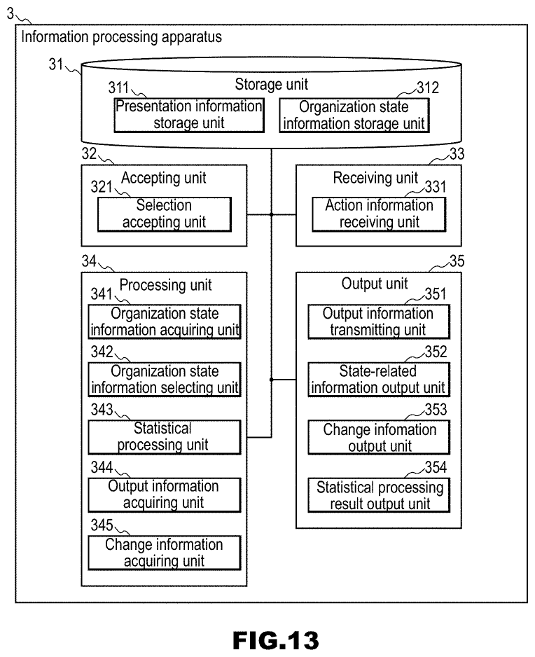

FIG. 12 is a block diagram for the information system B according to the present embodiment. FIG. 13 is a block diagram for the information processing apparatus 3 according to the present embodiment.

The information processing apparatus 3 includes a storage unit 31, an accepting unit 32, a receiving unit 33, a processing unit 34, and an output unit 35. The storage unit 31 includes a presentation information storage unit 311 and an organization state information storage unit 312. The accepting unit 32 includes a selection accepting unit 321. The receiving unit 33 includes an action information receiving unit 331. The processing unit 34 includes an organization state information acquiring unit 341, an organization state information selecting unit 342, a statistical processing unit 343, an output information acquiring unit 344, and a change information acquiring unit 345. The output unit 35 includes an output information transmitting unit 351, a state-related information output unit 352, a change information output unit 353, and a statistical processing result output unit 354.

Each terminal apparatus 4 includes a terminal storage unit 41, a terminal accepting unit 42, a terminal processing unit 43, a terminal transmitting unit 44, a terminal receiving unit 45, and a terminal output unit 46.

Each management terminal 5 includes a management storage unit 51, a management accepting unit 52, a management processing unit 53, a management transmitting unit 54, a management receiving unit 55, and a management output unit 56.

The storage unit 31 included in the information processing apparatus 3 stores various kinds of information. Examples of various kinds of information include the later-described presentation information, the later-described organization state information, a member information database, the later-described action information, item information, organization response information, and an individual score table. The organization response information may be referred to as response information.

The member information database includes one or more pieces of member information. The member information is information regarding a member. Member information includes a member identifier that identifies a member and an organization identifier that identifies an organization to which the member belongs. It is preferable that member information includes a sector identifier that identifies a sector to which the member belongs. As a matter of course, the member information database may be a relational database, an object-oriented database, a CSV file, or the like, and there is no limitation on the data structure thereof. A member identifier is, for example, an ID, the name of the member, a mail address, or a telephone number. The organization identifier is, for example, an ID, an organization name, or the like. The sector identifier is, for example, an ID, a sector name, or the like. The member information may include a presentation information identifier that specifies presentation information that has been browsed by the member, and browsing time.

Although not shown in the drawings, the storage unit 31 may include, an item information storage unit 111, an organization response information storage unit 112, an individual score table storage unit 113, and an organization information storage unit 114.

The presentation information storage unit 311 stores one or more pieces of presentation information. The presentation information is information that is to be presented to a member. The presentation information is information that is to be presented to a member to improve the organization and educate the member. The presentation information is, for example, an article, an in-house newsletter, or the like. The presentation information is, for example, a moving image, a still image, a sentence, or the like, and there is no limitation on the data format or data structure thereof. The presentation information in the presentation information storage unit 311 is, for example, association with a selection condition that is a condition for selection. The selection condition is, for example, an item identifier of an improvement item, a condition that employs a score, or the like. The improvement item is, for example, an item to be improved of the items described in Embodiment 1. Note that the presentation information with which the item identifier of an improvement item (for example, “impact in the industry”) is associated indicates that the improvement item (for example, “impact in the industry”) is expected to be improved if the presented information is browsed. In addition, it is preferable that the presentation information is associated with an attribute value other than the item identifier of an improvement item. Examples of such an attribute value include a title, the number of viewers, a browsing time, and so on.

The organization state information storage unit 312 stores organization state information. Organization state information is information regarding the state of an organization. Organization state information is information that is based on response information regarding a response to a question to a member regarding an organization. Organization state information is, for example, an item identifier that identifies an improvement item, a set of item identifier and an item score, and a score. The score is, for example, the above-described absolute item score, a relative item score, an overall score, or an attribute value-considering overall score.

It is preferable that the organization state information in the organization state information storage unit 312 is associated with one or more identifiers of: the organization identifier; the sector identifier; and the member identifier that identifies a member. That is to say, an item identifier that identifies the improvement item to be improved by the organization is associated with the organization identifier. Also, an item identifier that identifies the improvement item to be improved by the sector is associated with the sector identifier. Also, an item identifier that identifies the improvement item to be improved by the member is associated with the member identifier.

It is preferable that the organization state information storage unit 312 stores first organization state information as of a first point in time that is earlier than when the output information transmitting unit 351 transmits output information, and second organization state information as of a second point in time that is later than when the output information transmitter 351 transmits output information. That is to say, it is preferable that time point information that specifies the time with the organization state information is acquired or the time with questionnaire is conducted is associated with organization state information. It may be considered that the second point in time later than when output information is transmitted is the point in time later than when output information is transmitted and the output information is browsed.

It is preferable that organization state information is any one of one or more types of organization state information of: first type organization state information regarding an overall statistical processing result that is a statistical processing result regarding the entire organization obtained by performing statistical processing on response information regarding a response to a questionnaire directed to two or more members of the organization; second type organization state information regarding a sector statistical processing result that is a statistical processing result obtained by performing statistical processing on response information regarding a response to a questionnaire directed to two or more members of a sector to which two or more members of the organization belong; and third type organization state information regarding a response to a questionnaire directed to each member.

The accepting unit 32 accepts various kinds of information and instructions. Examples of various kinds of information and instructions include selection of the later-described state related information. Note that “acceptance” is a concept that encompasses accepting information input from an input device such as a keyboard, a mouse, or a touch panel, receiving information transmitted via a wired or wireless communication network, accepting information read from a recording medium such as an optical disk, a magnetic disk, a semiconductor memory, or the like.

Note that any input means may be employed to input various kinds of information, instructions, and so on, such as a touch panel, a keyboard, a mouse, a menu screen, or the like. The accepting unit 32 may be realized using, for example, a device driver for the input means such as a touch panel or a keyboard, or control software or the like for controlling the menu screen. However, the accepting unit 32 may be realized using a wired or wireless receiving means.

The selection accepting unit 321 accepts selection of one or more pieces of state-related information of two or more pieces of state-related information that has been output by the state-related information output unit 352. Note that state-related information is information regarding organization state information. The state-related information is, for example, an item identifier that identifies an improvement item, or item information that includes an item identifier and an item score. Note that any input means may be employed to select state-related information, such as a touch panel, a keyboard, a mouse, a menu screen, or the like. The selection accepting unit 321 may be realized using, for example, a device driver for the input means such as a touch panel or a keyboard, or control software or the like for controlling the menu screen. However, the selection accepting unit 321 may be realized using a wired or wireless receiving means.

The receiving unit 33 receives various kinds of information. Examples of various kinds of information include the later-described action information. Examples of various kinds of information include an instruction to browse presentation information. An instruction to browse presentation information includes a presentation information identifier that identifies presentation information that the user wishes to browse.

The action information receiving unit 331 receives action information. The action information receiving unit 331 typically receives action information from a terminal apparatus 4. The action information received by the action information receiving unit 331 typically is associated with a member identifier. The action information received by the action information receiving unit 331 typically is associated with a presentation information identifier. Action information is information regarding an action of a member performed in response to output information that has been transmitted by the output information transmitting unit 351. Action information is, for example, a presentation information identifier that identifies presentation information that has been browse on the terminal apparatus 4, a browsing time of the presentation information on the terminal apparatus 4, or a browsing date of the presentation information on the terminal apparatuses 4. Browsing time of presentation information is a period of time for which the presentation information has been output.

The processing unit 34 performs various kinds of processing. Examples of various kinds of information include the processing that is performed by the organization state information acquiring unit 341, the processing that is performed by the organization state information selecting unit 342, the processing that is performed by the statistical processing unit 343, the processing that is performed by the output information acquiring unit 344, and the processing that is performed by the change information acquiring unit 345.

The processing unit 34 accumulates, in association with a presentation information identifier that is paired with action information that has been received by the action information receiving unit 331, the received action information or information obtained by processing the received action information, in the presentation information storage unit 311. Note that, if action information is browsing time, the information obtained by processing the action information is, for example, browsing time obtained by adding the browsing time indicated by the action information to the browsing time already stored in association with the presentation information identifier. If action information is information that indicates that information has been browsed, the information obtained by processing the action information is, for example the number of viewers obtained by adding one to the number of viewers already stored in association with the presentation information identifier.

Also, for example, the processing unit 34 accumulates, in association with a member identifier that is paired with the action information received by the action information receiving unit 331, a presentation information identifier that is paired with the action information, in the member information database.

If the action information is browsing time, for example, the processing unit 34 accumulates, in association with a member identifier and a presentation information identifier that are paired with the action information received by the action information receiving unit 331, browsing time that is the action information, in the member information database.

Also, if presentation information is transmitted to a terminal apparatus 4 so as to be browsed, for example, the processing unit 34 increments the number of viewers that is paired with the presentation information identifier that identifies the presentation information by one, and accumulates the new number of viewers in pair with the presentation information identifier. Also, if presentation information is transmitted to a terminal apparatus 4 so as to be browsed, for example, the processing unit 34 accumulates the presentation information identifier in pair with the member identifier corresponding to the terminal apparatus 4 to specify the browed presentation information.

The organization state information acquiring unit 341 analyzes response information that is a response to a questionnaire directed to one or more members of the organization, acquires organization state information, and accumulates the organization state information in the organization state information storage unit 312. Although not shown in the drawings, the organization state information acquiring unit 341 may include the item score acquiring unit 131 or the item score acquiring unit 131 and the overall score acquiring unit 132. The organization state information acquiring unit 341 acquires organization state information by performing the same processing as the processing performed by the item score acquiring unit 131 or the item score acquiring unit 131 and the overall score acquiring unit 132.

For example, the organization state information acquiring unit 341 performs statistical processing on response information that is a response to an questionnaire directed to two or more members of an organization, acquires organization state information that is an overall statistical processing result that is a statistical processing result of the entire organization, and accumulates the organization state information in the organization state information storage unit 312 in association with the organization identifier of the organization.

For example, the organization state information acquiring unit 341 performs statistical processing on response information that is a response to a questionnaire directed to two or more members of a sector to which two or more members of an organization belong, acquires organization state information that is a sector statistical processing result, and accumulates the organization state information in the organization state information storage unit 312 in association with the sector identifier of the sector. Note that the sector statistical processing result is a statistical processing result regarding the entire sector.

For example, the organization state information acquiring unit 341 acquires organization state information, using one or more kinds of information included in the response to the questionnaire from each member, and accumulates the organization state information in the organization state information storage unit 312 in association with the member identifier.

For example, the organization state information acquiring unit 341 analyzes first response information that is a response to the questionnaire directed to one or more members of the organization as of the first point in time that is earlier than when the output information transmitting unit 351 transmits output information, to acquire first organization state information. For example, the organization state information acquiring unit 341 analyzes second response information that is a response to the questionnaire directed to one or more members of the organization as of the second point in time that is later than when the output information transmitting unit 351 transmits output information, to acquire second organization state information. That is to say, it is preferable that the organization state information acquiring unit 341 acquires organization state information as of two or more points in time.

Note that if the response information to be analyzed is response information regarding the members of the entirety of one organization, the organization state information acquiring unit 341 accumulates the first organization state information and the second organization state information in the organization state information storage unit 312, in association with the organization identifier of the organization. If the response information to be analyzed is response information regarding the members of the entirety of one sector, the organization state information acquiring unit 341 accumulates the first organization state information and the second organization state information in the organization state information storage unit 312, in association with the sector identifier of the sector. If the response information to be analyzed is response information regarding one member, the organization state information acquiring unit 341 accumulates the first organization state information and the second organization state information in the organization state information storage unit 312, in association with the member identifier of the member.

The organization state information selecting unit 342 selects one or more pieces of organization state information that satisfy a state selection condition that is a predetermined condition, from among two or more pieces of organization state information. The state selection condition is a condition for selecting organization state information. The state selection condition is, for example, a condition regarding a score, or a condition regarding an improvement item. The state selection condition is, for example, “item with an item score no greater than a threshold value or less than a threshold value”. The state selection condition is, for example, an item that is “improvement item”.

The statistical processing unit 343 performs statistical processing on the action information received by the action information receiving unit 331, to acquire a statistical processing result. The statistical processing result is, for example, the number of members that has browsed each piece of presentation information, the period of time for which one or more members have browsed each presentation information, the number of pieces of presentation information that have been browsed, for each organization state information, and the total time for which each piece of organization state information has been browsed. The statistical processing result is, for example, the number of time “Like” button or a button similar to “Like” button is pressed for the presentation information. The statistical processing result is, for example, the proportion of the pressing of the “Like” button or the button similar to “Like” button for the presentation information. Note that the proportion is “the number of members that have pressed the “Like” button or the like divided by the number of members that have browsed the presentation information.

For example, the output information acquiring unit 344 determines one or more pieces of presentation information that are to be presented to the members of the organization, from among the pieces of presentation information stored in the presentation information storage unit 311, using the organization state information. For example, the output information acquiring unit 344 selects presentation information that is associated with the item identifier of the item for which the item score, which is organization state information, is no greater than a threshold value or less than a threshold value, from the presentation information storage unit 311. For example, the output information acquiring unit 344 selects one or more pieces of presentation information that is associated with the item identifier that identifies an improvement item, is organization state information, from the presentation information storage unit 311.

For example, the output information acquiring unit 344 changes the presentation information stored in the presentation information storage unit 311 so as to be in a presentation mode for a member of the organization. For example, the output information acquiring unit 344 determines the order of item identifiers according to ascending order of the item scores that are organization state information, sorts two or more pieces of presentation information that are pieces of presentation information associated with the item identifiers and are stored in the presentation information storage unit 311, according to the order of the item identifiers, and forms output information that is screen information that constitutes a screen that is used to select one of the two or more pieces of presentation information that have been sorted.

For example, the output information acquiring unit 344 determines one or more pieces of presentation information that are to be presented to the members of the organization, from among the pieces of presentation information stored in the presentation information storage unit 311, using one or more pieces of state-related information corresponding to the selection accepted by the selection accepting unit 321. Note that the state-related information is information output by the later-described state-related information output unit 352. The state-related information may be organization state information or information that specifies organization state information. The state-related information is, for example, an item identifier that specifies the item to be improved. For example, the output information acquiring unit 344 determines presentation information that is paired with the item identifier specified by one or more pieces of state-related information corresponding to the selection accepted by the selection accepting unit 321. Note that determination of presentation information is, for example, acquisition of the presentation information, acquisition of points for the presentation information, acquisition of information that specifies the presentation information, or the like.

For example, the output information acquiring unit 344 changes the presentation information stored in the presentation information storage unit 311 so as to be in a presentation mode for a member of the organization, using one or more pieces of state-related information corresponding to the selection accepted by the selection accepting unit 321. The output information acquiring unit 344 sorts the two or more pieces of presentation information stored in the presentation information storage unit 311 so that a selection object (for example, a button or a menu item) with which presentation information that is paired with the item identifier specified by the one or more pieces of state-related information corresponding to the selection accepted by the selection accepting unit 321 can be selected is positioned at a higher position, and forms output information that is screen information that constitutes a screen that is used to select one of the two or more pieces of presentation information that have been sorted.

For example, the output information acquiring unit 344 determines one or more pieces of presentation information that are to be presented to the members of the organization, from among the pieces of presentation information stored in the presentation information storage unit 311, using the one or more pieces of organization state information selected by the organization state information selecting unit 342.

For example, the output information acquiring unit 344 changes the presentation information stored in the presentation information storage unit 311 so as to be in a presentation mode for a member of the organization. Changing information so as to be in a presentation mode for the members of the organization is, for example, sorting two or more presentation information stored in the presentation information storage unit 311, using one or more attribute values paired with the presentation information as keys, and forming output information that is screen information that constitutes a screen that is used to select one of the two or more pieces of presentation information that have been sorted. Changing information so as to be in a presentation mode for the members of the organization is, for example, selecting pieces of presentation information that satisfies a predetermined condition from the presentation information storage unit 311, and forming output information that is screen information that constitutes a screen that is used to select one of the pieces of presentation information that have been selected. Changing information so as to be in a presentation mode for the members of the organization may be, for example, sorting the pieces of presentation information in order of recommendation, explicitly showing the degrees of recommendation in association with the pieces of presentation information, and so on.

For example, the output information acquiring unit 344 determines the presentation information to be presented to the members of the organization, from among the pieces of presentation information stored in the presentation information storage unit 311, using the action information received by the action information receiving unit 331. Determining the presentation information using the action information is, for example, performing statistical processing on the action information received by the action information receiving unit 331 to acquire other pieces of presentation information that are paired with the item identifier paired with presentation information whose number of views is less than the threshold value. Determining the presentation information using the action information is, for example, acquiring presentation information that has been viewed by a percentage of other members no less than a threshold value, and that has not been viewed by the member, form the action information received by the action information receiving unit 331. It is assumed that the presentation information identifiers of the pieces of presentation information that have been viewed by the members are managed in the member database in association with the member identifiers.

Note that using the action information may be using the statistical processing result that is the result of the statistical processing performed on the action information. Such statistical processing result may be a statistical processing result with respect to the action information regarding all the members, a statistical processing result with respect to the action information excluding the target member, or a statistical processing result with respect to the action information regarding only the target member.

For example, the output information acquiring unit 344 determines one or more pieces of presentation information that are to be presented to the members of the organization, from among the pieces of presentation information stored in the presentation information storage unit 311, using the action information received by the action information receiving unit 331 and organization state information associated with output information. Determining the presentation information using the action information and the organization state information associated with the output information is, for example, when the viewing ratio of one or more pieces of presentation information paired with the item identifier, which is an example of organization state information, is lower than an average value of the viewing ratio by a threshold value or more in the statistical processing result on the action information, determining one or more pieces of presentation information that are paired with the item identifier paired with the presentation information with the low viewing ratio, as presentation information that are to be recommended.

For example, the output information acquiring unit 344 determines the presentation information to be presented to the members of the organization, from among the pieces of presentation information stored in the presentation information storage unit 311, using the organization state information, in association with the type identifier corresponding to the organization state information.

A type identifier is information that identifies the type of organization state information. The type identifier is information of any one of one or more types of organization state information, namely first type organization state information, second type organization state information, or third type organization state information.

The first type organization state information is information obtained by performing statistical processing on response information that is a response to a questionnaire to two or more members of an organization, and is information regarding an overall statistical processing result that is a statistical processing result regarding the entire organization. The first type organization state information is, for example, an item identifier that is a result of analyzing the response information regarding the questionnaire to all the members of the organization, and that corresponds to an item score that is no greater than a threshold value or less than a threshold value.

The first type organization state information is information obtained by performing statistical processing on response information that is a response to a questionnaire to two or more members of the sector of an organization to which the two or more members belong, and is information regarding a sector statistical processing result of the sector. The second type organization state information is, for example, an item identifier that is a result of analyzing the response information regarding the questionnaire to all the members of a sector, and that corresponds to an item score that is no greater than a threshold value or less than a threshold value.

The third type organization state information is information obtained by performing statistical processing on response information regarding a response from one member to a questionnaire, and is information regarding a member statistical processing result that is a statistical processing result of the member. The third organization state information is, for example, an item identifier that corresponds to a score that is low enough to satisfy a predetermined condition, of two or more item scores of one member. Note that a score that is low enough to satisfy a predetermined condition is, for example, the lowest item score, the lowest N item scores (N is a natural number no less than 2), an item score lower than the average value of the item scores by a threshold value or more, or the like.

The change information acquiring unit 345 acquires change information regarding a difference between the first organization state information and the second organization state information. Note that the first organization state information is organization state information as of the first point in time that is earlier than when the output information transmitting unit 351 transmits output information. The second organization state information is organization state information as of the second point in time that is later than when the output information transmitting unit 351 transmits output information. For example, the change information acquiring unit 345 acquires change information that is the difference between the item score of a specific item (for example, an improvement item) as of the first point in time and the item score as of the second point in time.

The output unit 35 acquires various kinds of information. Examples of various kinds of information include output information, presentation information, state-related information, change information, and a statistical processing result. Here, “output” typically means transmission to an external apparatus such as a terminal apparatus 4. However, it may be regarded as a concept that includes displaying on a display device, projection with a projector, printing with a printer, sound output, accumulation on a recording medium, delivery of processing results to another processing apparatus or another program, and so on.

The output information transmitting unit 351 transmits the output information acquired by the output information acquiring unit 344. The output information transmitting unit 351 typically transmits the output information to a terminal apparatus 4.

For example, the output information transmitting unit 351 transmits screen information that has been acquired by the output information acquiring unit 344 and constitutes a screen that is used to select one of two or more pieces of presentation information.

For example, the output information transmitting unit 351 transmits one or more pieces of presentation information that has been determined by the output information acquiring unit 344. The output information transmitting unit 351 transmits the output information that is presentation information that has been changed by the output information acquiring unit 344.

For example, the output information transmitting unit 351 transmits the output information that is presentation information that has been determined by the output information acquiring unit 344 or presentation information that has been changed by the output information acquiring unit 344, in association with a type identifier. In such a case, the type identifier is associated with organization state information (for example, an item identifier).

For example, the output information transmitting unit 351 transmits presentation information that is identified by presentation information that is included in a presentation information browsing instruction.

Note that there is no limitation on the time when the output information transmitting unit 351 outputs output information. For example, the output information transmitting unit 351 transmits output information (for example, screen information regarding a presentation information selection screen, or presentation information) after the terminal apparatus 4 of a member logs in to the information processing apparatus 3. For example, the output information transmitting unit 351 transmits output information (for example, screen information regarding a presentation information selection screen, or presentation information) upon receiving an instruction from the terminal apparatus 4 of a member. For example, the output information transmitting unit 351 transmits presentation information upon receiving a browsing instruction from the terminal apparatus 4 of the member.

For example, the state-related information output unit 352 outputs two or more pieces of state-related information regarding the organization state information stored in the organization state information storage unit 312, for example. The state-related information may be organization state information or information that specifies organization state information. Note that “output” here is transmission to a management terminal 5, for example. However, it may be output or the like to a display.

For example, the state-related information output unit 352 outputs two or more pieces of state-related information regarding one or more pieces of organization state information selected by the organization state information selecting unit 342, for example.

The change information output unit 353 outputs the change information acquired by the change information acquiring unit 345. Note that “output” here is transmission to a management terminal 5, for example. However, it may be output or the like to a display.

The statistical processing result output unit 354 outputs the statistical processing result acquired by the statistical processing unit 343. Note that “output” here is transmission to a terminal apparatus 4 or a management terminal 5, for example. However, it may be output or the like to a display.

The terminal storage unit 41 included in a terminal apparatus 4 stores various kinds of information. Examples of various kinds of information include an organization identifier that identifies the organization of a user, and a member identifier that identifies a member. Examples of various kinds of information include information that has been received by the terminal receiving unit 25.

The terminal accepting unit 42 accepts various instructions, information, and so on. Here, “acceptance” is a concept that encompasses accepting information input from an input device such as a keyboard, a mouse, or a touch panel, receiving information transmitted via a wired or wireless communication network, accepting information read from a recording medium such as an optical disk, a magnetic disk, a semiconductor memory, or the like.

Examples of various kinds of instructions and information include a login instruction, a logout instruction, selection of presentation information, a presentation information browsing instruction, organization response information, questionnaire response information, organization information that includes an organization identifier and an organization attribute value, and so on. Note that the login instruction is an instruction to log in to the information processing apparatus 3. The logout instruction is an instruction to log out from the information processing apparatus 3. The selection of presentation information is an instruction to select the presentation information to be browsed. The selection of presentation information typically includes a presentation information identifier.

The terminal processing unit 43 performs various kinds of processing. Examples of various kinds of processing include processing that is performed to form data that is to be displayed, using information that has been received by the terminal receiving unit 45. Examples of various kinds of processing include processing that is performed to form an instruction or the like that is to be transmitted, from an instruction or the like that has been accepted by the terminal accepting unit 42.

The terminal processing unit 43 may measure the time during which the presentation information is output to acquire the browsing time in pair with the presentation information identifier.

The terminal transmitting unit 44 transmits various instructions, information, and so on to the information processing apparatus 3. Examples of various instructions, information, and so on include an instruction formed by the terminal processing unit 43, an instruction, information, or the like that has been accepted by the terminal accepting unit 42, the browsing time acquired by the terminal processing unit 43, the presentation information identifier that identifies the browsed presentation information, and so on.

The terminal receiving unit 45 transmits various kinds of information from the information processing apparatus 3. Examples of various kinds of information include output information, presentation information, state-related information, change information, and a statistical processing result.

The terminal output unit 46 outputs various kinds of information. Examples of various kinds of information include information that has been accepted by the terminal accepting unit 42, information that has been received by the terminal receiving unit 45, and information that has been formed by the terminal processing unit 43. Examples of various kinds of information include output information, presentation information, state-related information, change information, and a statistical processing result.

If the received output information is screen information, the terminal output unit 46 outputs a presentation information selection screen.

The management storage unit 51 included in the management terminals 5 stores various kinds of information. Examples of various kinds of information include an organization identifier that identifies the organization to which an administrator belongs, and an administrator identifier that identifies the administrator. Examples of various kinds of information include information that has been received by the management receiving unit 55.

The management accepting unit 52 accepts various instructions, information, and so on. Here, “acceptance” is a concept that encompasses accepting information input from an input device such as a keyboard, a mouse, or a touch panel, receiving information transmitted via a wired or wireless communication network, accepting information read from a recording medium such as an optical disk, a magnetic disk, a semiconductor memory, or the like. Examples of various kinds of instructions, information, and so on include, for example, an organization state information output instruction, a selection of one or more pieces of state-related information, and so on. Note that the organization state information output instruction is an instruction to output organization state information (for example, a set of item scores of an organization, a sector, or a member). The output instruction includes an organization identifier, for example.

The management processing unit 53 performs various kinds of processing. Examples of various kinds of processing include processing that is performed to form data that is to be displayed, using information that has been received by the management receiving unit 55. Examples of various kinds of processing include processing that is performed to form an instruction or the like that is to be transmitted, from an instruction or the like that has been accepted by the management accepting unit 52.

The management transmitting unit 54 transmits various instructions, information, and so on to the information processing apparatus 3. Examples of various kinds of instructions, information, and so on include, for example, a selection of one or more pieces of state-related information, and so on.

The management receiving unit 55 receives various kinds of information from the information processing apparatus 3. Various kinds of information are, for example, two or more pieces of state-related information output by the state-related information output unit 352.

The management output unit 56 outputs various kinds of information. Examples of various kinds of information include information that has been accepted by the management accepting unit 52, information that has been received by the management receiving unit 55, and information that has been formed by the management processing unit 53.

It is preferable that the storage unit 31, the presentation information storage unit 311, the organization state information storage unit 312, the terminal storage unit 41, and the management storage unit 51 are realized using a non-volatile recording medium, but they may be realized using a volatile recording medium.

There is no limitation on the process in which information is stored in the storage unit 31 and so on. For example, information may be stored in the storage unit 31 or the like via a recording medium, or information transmitted via a communication line or the like may be stored in the storage unit 31 or the like, or information input via an input device may be stored in the storage unit 31 or the like.

The receiving unit 33, the action information receiving unit 331, the terminal receiving unit 45, and the management receiving unit 55 typically are realized using a wireless or wired communication means, but they may be realized using a means for receiving broadcast.

The processing unit 34, the organization state information acquiring unit 341, the organization state information selecting unit 342, the statistical processing unit 343, the output information acquiring unit 344, the change information acquiring unit 345, the terminal processing unit 43, and the management processing unit 53 may typically be realized using an MPU, a memory, or the like. The processing procedures performed by the processing unit 34 typically are realized using software, and the software is recorded on a recording medium such as a ROM. However, such processing procedures may be realized using hardware (a dedicated circuit).

The output unit 35, the output information transmitting unit 351, the state-related information output unit 352, the change information output unit 353, the statistical processing result output unit 354, the terminal transmitting unit 44, and the management transmitting unit 54 typically are realized using a wireless or wired communication means, but they may be realized using a means for receiving broadcast.

The terminal accepting unit 42 and the management accepting unit 52 may be realized using a device driver for the input means such as a touch panel or a keyboard, or control software or the like for controlling the menu screen.

The terminal output unit 46 and the management output unit 56 may or may not include an output device such as a display or a speaker. The terminal output unit 46 and so on may be realized using the driver software of the output device, the driver software of the output device and the output device, or the like.

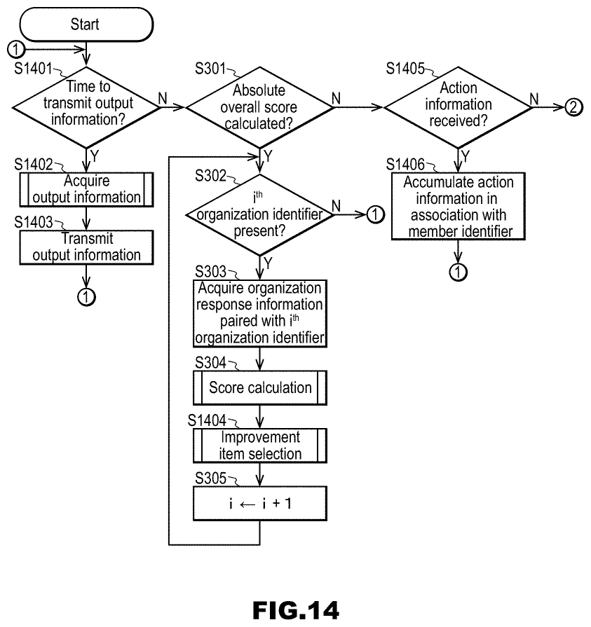

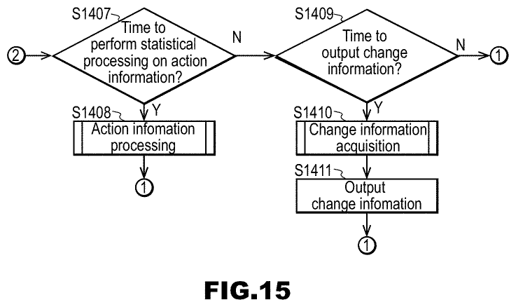

Next, examples of operations of the information processing apparatus 3 included in the information system B will be described with reference to the flowchart shown in FIGS. 14 and 15. Regarding the flowchart in FIG. 14, descriptions of the same steps as in the flowchart in FIG. 3 will be omitted. It is assumed that the storage unit 31 stores organization response information regarding multiple organizations. It is also assumed that the storage unit 31 stores an individual score table.

(Step S1401) The processing unit 34 determines whether or not it is the time to transmit output information to a terminal apparatus 4. If it is the time to transmit output information, processing proceeds to step S1402, and if it is not the time to transmit output information, processing proceeds to step S301. Note that the processing unit 34 determines that it is the time to transmit output information when an instruction to transmit output information has been accepted from a terminal apparatus 4, when login to the information processing apparatus 3 from a terminal apparatus 4 is performed, and so on. It is also assumed that information that is included in the instruction to transmit output information or information transmitted at the time of login typically includes a member identifier. It is also assumed that the organization identifier and the sector identifier paired with the member identifier can be acquired from the member information database in the storage unit 31.

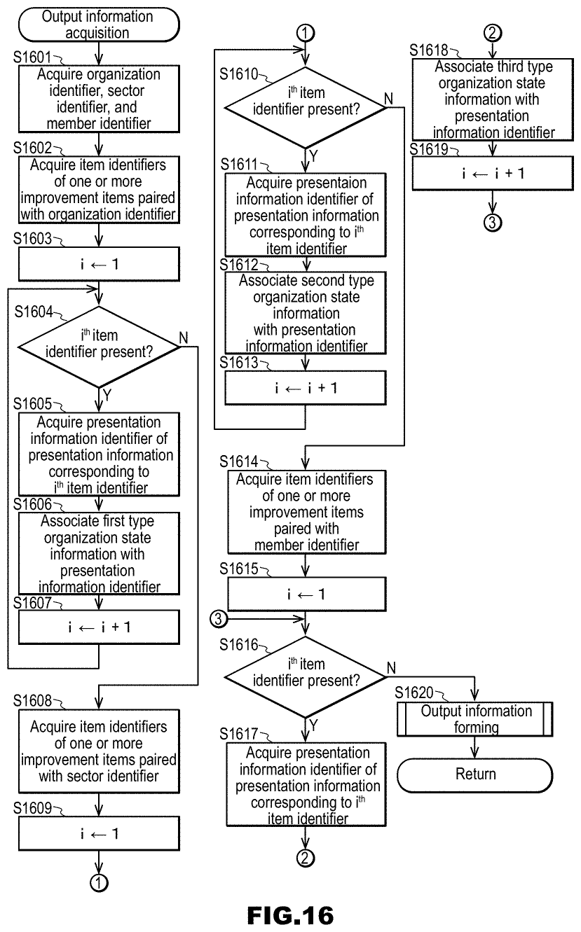

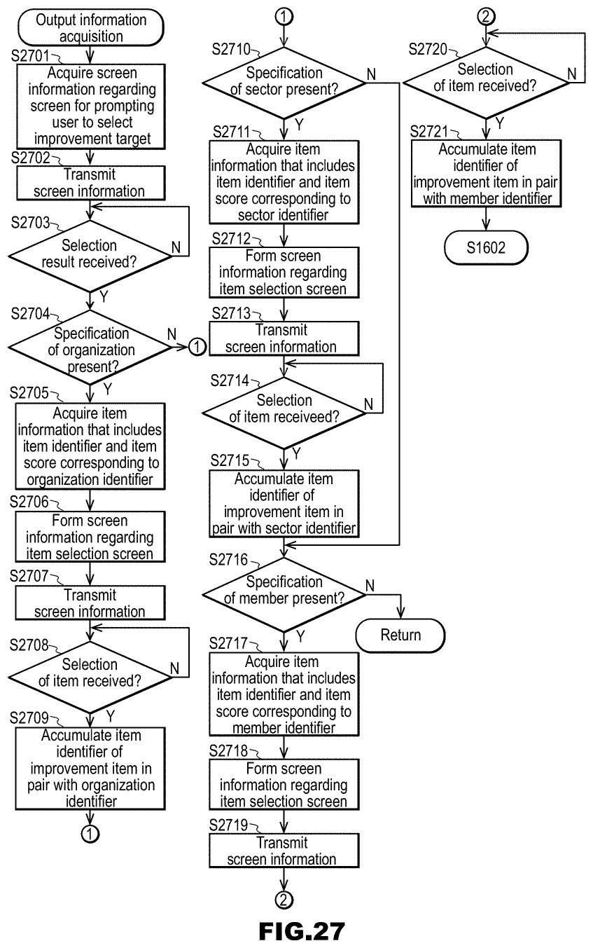

(Step S1402) The output information acquiring unit 344 performs output information acquisition processing. An example of output information acquisition processing will be described with reference to the flowcharts shown in FIGS. 16 and 27.

(Step S1403) The output information transmitting unit 351 transmits the output information acquired in step S1402. Processing returns to step S1401. Note that the transmission destination of the output information is a terminal apparatus 4. The transmission destination of the output information is, for example, a terminal apparatus 4 that has transmitted an instruction to transmit output information, or a terminal apparatus 4 that has logged in to the information processing apparatus 3.

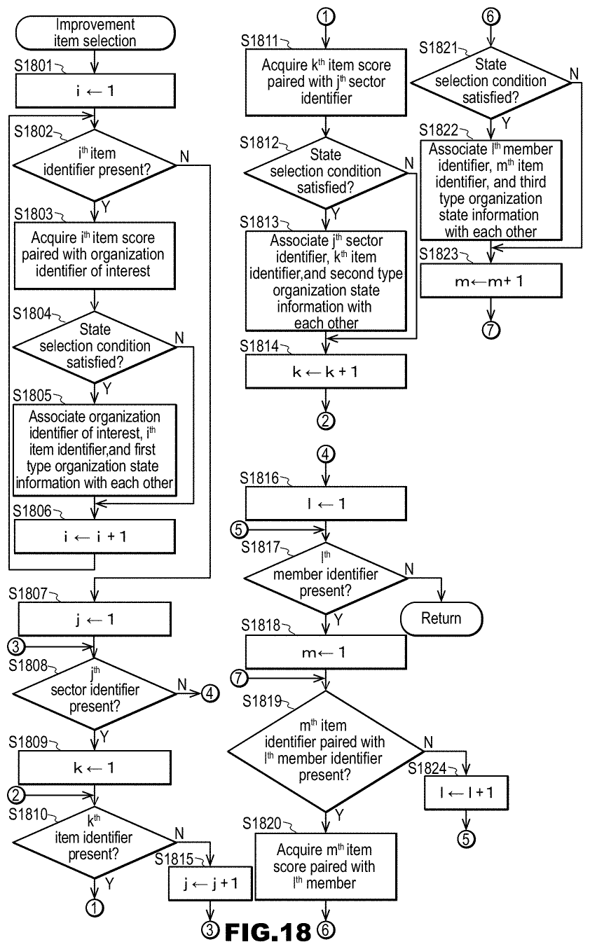

(Step S1404) The organization state information selecting unit 342 performs improvement item selection processing. An example of improvement item selection processing will be described with reference to the flowchart shown in FIG. 18.

(Step S1405) The action information receiving unit 331 determines whether or not action information has been received. If action information has been received, processing proceeds to step S1406, and if action information has not been received, processing proceeds to step S1407.

(Step S1406) The processing unit 34 accumulates the action information received in step S1405 in the storage unit 31 or a buffer (not shown) in pair with the member identifier associated with the action information. Processing returns to step S1401.

(Step S1407) The processing unit 34 determines whether or not it is the time to perform statistical processing on the action information stored in the storage unit 31 or a buffer (not shown). If it is the time to perform statistical processing, processing proceeds to step S1408, and if it is not the time to perform statistical processing, processing proceeds to step S1409. For example, the processing unit 34 determines that it is the time to perform statistical processing, on a regular basis (for example, once a month, once every 6 months, once a year, or the like). Also, the processing unit 34 determines that it is the time to perform statistical processing upon receiving an instruction to perform statistical processing from a management terminal 5. There is no limitation on the time to perform statistical processing.

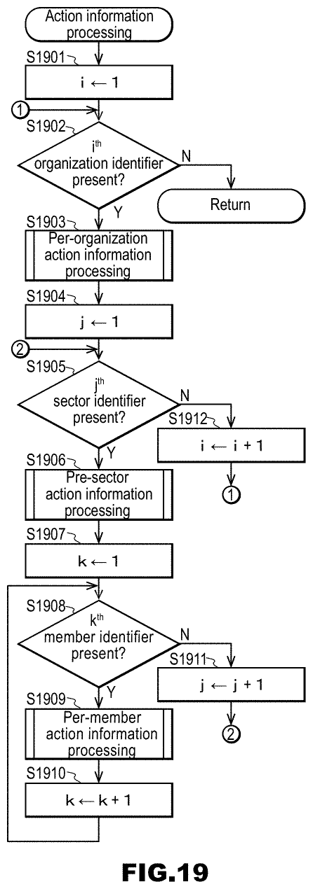

(Step S1408) The statistical processing unit 343 performs action information processing that is statistical processing performed on action information. An example of action information processing will be described with reference to the flowchart shown in FIG. 19.

(Step S1409) The processing unit 34 determines whether or not it is the time to transmit output change information. If it is determined that it is the time to output change information, processing proceeds to step S1410, and if it is determined that it is not the time to output change information, processing returns to step S1401. For example, the processing unit 34 determines that it is the time to output change information if an instruction to output change information is received from a terminal apparatus 4 or a management terminal 5. For example, the processing unit 34 determines that it is the time to output change information, on a regular basis (for example, once a month, once every 6 months, once a year, or the like). Also, for example, the processing unit 34 determines that it is the time to output change information if the second or later piece of organization state information associated with one organization identifier is accumulated in the organization state information storage unit 312.

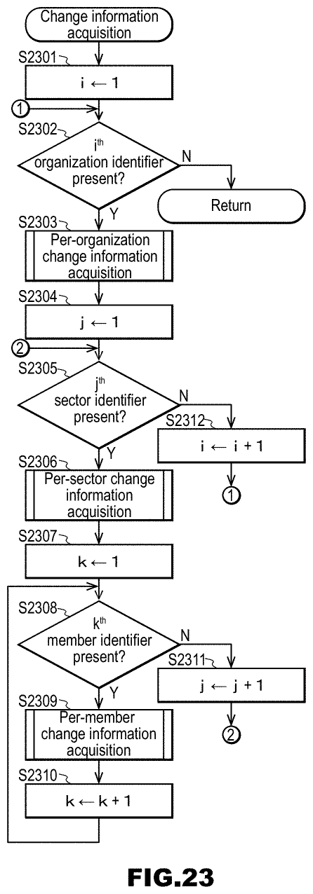

(Step S1410) The change information acquiring unit 345 performs change information acquisition processing. An example of change information acquisition processing will be described with reference to the flowchart shown in FIG. 23.

(Step S1411) The change information output unit 353 outputs the change information acquired in step S1410. Processing returns to step S1401.

Note that the processing in step S304 in the flowchart shown in FIG. 14 is performed by the organization state information acquiring unit 341 at this time. The organization state information here includes one or more scores of: an overall score associated with an organization identifier; an item score of each item associated with an organization identifier; an overall score associated with a sector identifier; an item score of each item associated with a sector identifier; and an item score of each item associated with a member identifier. The organization state information may also include the attribute value-considering overall score and the relative item score described in Embodiment 1.

In the flowchart shown in FIG. 14, processing is terminated when power is turned off or an interruption is made to terminate the processing.

Next, a first example of the output information acquisition processing in step S1402 will be described with reference to the flowchart shown in FIG. 16.

(Step S1601) The output information acquiring unit 344 acquires the member identifier that identifies the member that is the user of the terminal apparatus 4 to which the output information is to be transmitted, the organization identifier, and the sector identifier. For example, the output information acquiring unit 344 acquires a member identifier that is included in an instruction transmitted from the terminal apparatus 4, to transmit output information. For example, the output information acquiring unit 344 acquires the member identifier received when the terminal apparatus 4 has logged in to the information processing apparatus 3. Thereafter, for example, the output information acquiring unit 344 acquires the organization identifier and the sector identifier paired with the member identifier, from the member information database in the storage unit 31. Note that if an organization identifier and a sector identifier have been received in addition to the member identifier, the output information acquiring unit 344 acquires the member identifier, the organization identifier, and the sector identifier thus received.

(Step S1602) The output information acquiring unit 344 acquires one or more item identifiers of the improvement items paired with the organization identifier acquired in step S1601, from the organization state information storage unit 312.

(Step S1603) The output information acquiring unit 344 substitutes 1 for the counter i.

(Step S1604) The output information acquiring unit 344 determines whether or not the i^{th} item identifier is present in the one or more item identifiers acquired in step S1602. If the i^{th} item identifier is present, processing proceeds to step S1605, and if the i^{th} item identifier is not present, processing proceeds to step S1608.

(Step S1605) The output information acquiring unit 344 acquires one or more presentation information identifiers that identify the presentation information paired with the i^{th} item identifier, from the presentation information storage unit 311. Here, there may be a case in which the presentation information identifier cannot be acquired.

(Step S1606) The output information acquiring unit 344 associates the first type organization state information with each of the one or more presentation information identifiers acquired in step S1605. Note that the association with the first type organization state information indicates that the presentation information identified by the presentation information identifier has been selected as recommended presentation information. Also, the association with the first type organization state information indicates that the presentation information identified by the presentation information identifier has been selected as recommended presentation information that is to be used to improve the organization to which the member belongs.

(Step S1607) The output information acquiring unit 344 increments the counter i by 1. Processing returns to step S1604.

(Step S1608) The output information acquiring unit 344 acquires one or more item identifiers of the improvement items paired with the sector identifier acquired in step S1601, from the organization state information storage unit 312.

(Step S1609) The output information acquiring unit 344 substitutes 1 for the counter i.

(Step S1610) The output information acquiring unit 344 determines whether or not the i^{th} item identifier is present in the one or more item identifiers acquired in step S1608. If the i^{th} item identifier is present, processing proceeds to step S1611, and if the i^{th} item identifier is not present, processing proceeds to step S1614.

(Step S1611) The output information acquiring unit 344 acquires one or more presentation information identifiers that identify the presentation information paired with the i^{th} item identifier, from the presentation information storage unit 311.

(Step S1612) The output information acquiring unit 344 associates second type organization state information with each of the one or more presentation information identifiers acquired in step S1611. Note that the association with the second type organization state information indicates that the presentation information identified by the presentation information identifier has been selected as recommended presentation information. Also, the association with the second type organization state information indicates that the presentation information identified by the presentation information identifier has been selected as recommended presentation information that is to be used to improve the sector to which the member belongs.

(Step S1613) The output information acquiring unit 344 increments the counter i by 1. Processing returns to step S1604.

(Step S1614) The output information acquiring unit 344 acquires one or more item identifiers of the improvement items paired with the member identifier acquired in step S1601, from the organization state information storage unit 312.

(Step S1615) The output information acquiring unit 344 substitutes 1 for the counter i.

(Step S1616) The output information acquiring unit 344 determines whether or not the i^{th} item identifier is present in the one or more item identifiers acquired in step S1614. If the i^{th} item identifier is present, processing proceeds to step S1617, and if the i^{th} item identifier is not present, processing proceeds to step S1620.

(Step S1617) The output information acquiring unit 344 acquires one or more presentation information identifiers that identify the presentation information paired with the i^{th} item identifier, from the presentation information storage unit 311. Here, there may be a case in which the presentation information identifier cannot be acquired.

(Step S1618) The output information acquiring unit 344 associates the third type organization state information with each of the one or more presentation information identifiers acquired in step S1617. Note that the association with the third type organization state information indicates that the presentation information identified by the presentation information identifier has been selected as recommended presentation information. Also, the association with the third type organization state information indicates that the presentation information identified by the presentation information identifier has been selected as recommended presentation information that is to be used to improve the member.

(Step S1619) The output information acquiring unit 344 increments the counter i by 1. Processing returns to step S1604.

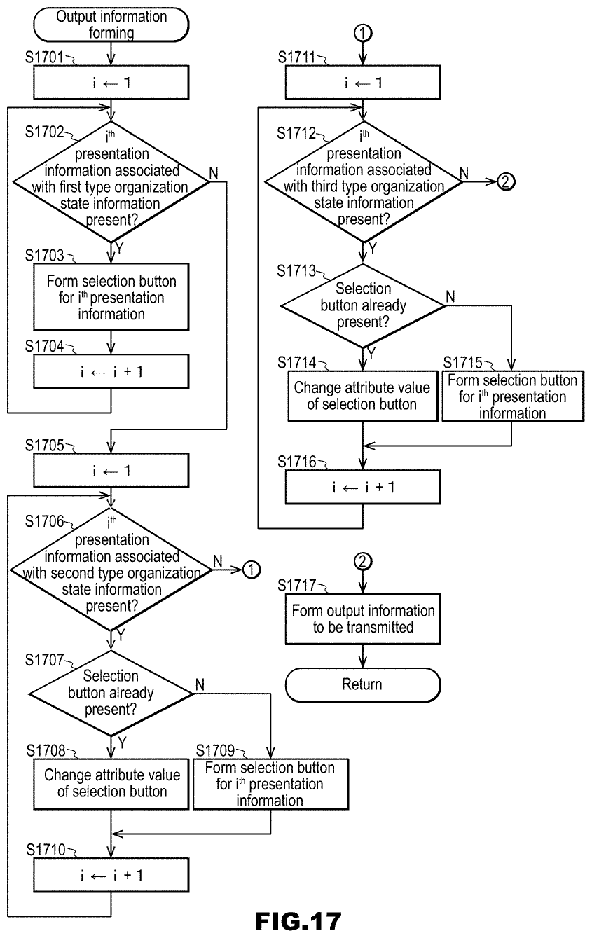

(Step S1620) The output information acquiring unit 344 performs output information acquisition processing. An example of output information forming processing will be described with reference to the flowchart shown in FIG. 17.

Next, an example of the output information forming processing in step S1620 will be described with reference to the flowchart shown in FIG. 17.

(Step S1701) The output information acquiring unit 344 substitutes 1 for the counter i.

(Step S1702) The output information acquiring unit 344 determines whether or not the i^{th} piece of presentation information associated with the first type organization state information is present. If the i^{th} piece of presentation information associated with the first type organization state information is present, processing proceeds to step S1703, and if it is not present, processing proceeds to step S1705.

(Step S1703) The output information acquiring unit 344 forms a selection button that is used to select the i^{th} piece of presentation information. For example, the output information acquiring unit 344 acquires a still image that represents the i^{th} piece of presentation information that is a moving image, and when the still image is pressed, information (for example the URL to the i^{th} piece of presentation information) that is used to output (for example, download) the i^{th} piece of presentation information is linked with the still image. Note that the technique for forming a still image as a button is well-known technique, and therefore the detailed description thereof is omitted. In addition, it is preferable that the output information acquiring unit 344 provides the attribute values of the i^{th} piece of presentation information (for example, the title, the item identifier of the improvement item, the number of viewers, and so on) around the selection button for the i^{th} piece of presentation information or around the selection button. Note that the attribute values of the i^{th} piece of presentation information are stored in the presentation information storage unit 311 in association with the presentation information. It is also preferable that the output information acquiring unit 344 provides information indicating that the i^{th} piece of presentation information is associated with the first organization state information, around the selection button for the i^{th} piece of presentation information or in the selection button, or sets an attribute value (for example, the background color) of the selection button to an attribute value indicating that the piece of presentation information is associated with the first organization state information.

(Step S1704) The output information acquiring unit 344 increments the counter i by 1. Processing returns to step S1702.

(Step S1705) The output information acquiring unit 344 substitutes 1 for the counter i.

(Step S1706) The output information acquiring unit 344 determines whether or not the i^{th} piece of presentation information associated with the second type organization state information is present. If the i^{th} piece of presentation information associated with the second type organization state information is present, processing proceeds to step S1707, and if it is not present, processing proceeds to step S1711.

(Step S1707) The output information acquiring unit 344 determines whether or not a selection button corresponding to the i^{th} piece of presentation information has already been formed in step S1703. If the selection button has been formed, processing proceeds to step S1708, and if it has not been formed, processing proceeds to step S1709.

(Step S1708) For example, the output information acquiring unit 344 sets the attribute value (for example, the background color) of the selection button corresponding to the i^{th} piece of presentation information to an attribute value indicating that the piece of presentation information is associated with the second organization state information. Alternatively, for example, the output information acquiring unit 344 provides information indicating that the i^{th} piece of presentation information is associated with the second organization state information, around the selection button for the i^{th} piece of presentation information or in the selection button.

(Step S1709) The output information acquiring unit 344 forms a selection button that is used to select the i^{th} piece of presentation information. It is also preferable that the output information acquiring unit 344 provides information indicating that the i^{th} piece of presentation information is associated with the second organization state information, around the selection button for the i^{th} piece of presentation information or in the selection button, or sets an attribute value (for example, the background color) of the selection button to an attribute value indicating that the piece of presentation information is associated with the second organization state information.

(Step S1710) The output information acquiring unit 344 increments the counter i by 1. Processing returns to step S1706.

(Step S1711) The output information acquiring unit 344 substitutes 1 for the counter i.

(Step S1712) The output information acquiring unit 344 determines whether or not the i^{th} piece of presentation information associated with the third type organization state information is present. If the i^{th} piece of presentation information associated with the third type organization state information is present, processing proceeds to step S1713, and if it is not present, processing proceeds to step S1717.

(Step S1713) The output information acquiring unit 344 determines whether or not a selection button corresponding to the i^{th} piece of presentation information has already been formed in step S1703 or step S1709. If the selection button has been formed, processing proceeds to step S1714, and if it has not been formed, processing proceeds to step S1715.

(Step S1714) For example, the output information acquiring unit 344 sets the attribute value (for example, the background color) of the selection button corresponding to the i^{th} piece of presentation information to an attribute value indicating that the piece of presentation information is associated with the third organization state information. Alternatively, for example, the output information acquiring unit 344 provides information indicating that the i^{th} piece of presentation information is associated with the third organization state information, around the selection button for the i^{th} piece of presentation information or in the selection button.

(Step S1715) The output information acquiring unit 344 forms a selection button that is used to select the i^{th} piece of presentation information. It is also preferable that the output information acquiring unit 344 provides information indicating that the i^{th} piece of presentation information is associated with the third organization state information, around the selection button for the i^{th} piece of presentation information or in the selection button, or sets an attribute value (for example, the background color) of the selection button to an attribute value indicating that the piece of presentation information is associated with the third organization state information.

(Step S1716) The output information acquiring unit 344 increments the counter i by 1. Processing returns to step S1712.

(Step S1717) The output information acquiring unit 344 forms output information that is information regarding the screen in which the selection button formed through the above-described processing is provided. Processing returns to higher level processing.

In the flowchart shown in FIG. 17, although the selection button is formed so as to explicitly indicate that the presentation information selected with the selection button is associated with the first organization state information, the second organization state information, or the third organization state information, such processing is not essential.

Next, an example of the improvement item selection processing in Step S1404 will be described with reference to the flowchart shown in FIG. 18.

(Step S1801) The organization state information selecting unit 342 substitutes 1 for the counter i.

(Step S1802) The organization state information selecting unit 342 determines whether or not the i^{th} item identifier is present. If the i^{th} item identifier is present, processing proceeds to step S1803, and if the i^{th} item identifier is not present, processing proceeds to step S1807. Note that all the item identifiers are stored in the storage unit 31. Also, it may be considered that whether or not the i^{th} item identifier is present means the same as whether or not the i^{th} item score corresponding to the organization identifier of interest is present in the organization state information storage unit 312.

(Step S1803) The organization state information selecting unit 342 acquires an item score that is paired with the i^{th} item identifier corresponding to the organization identifier of interest, from the organization state information storage unit 312.

(Step S1804) The organization state information selecting unit 342 determines whether or not the i^{th} item score acquired in step S1803 satisfies the state selection condition (for example, “item score”<=threshold value” or “item score<threshold value”). If the i^{th} item score satisfies the state selection condition, processing proceeds to step S1805, and otherwise processing proceeds to step S1806.

(Step S1805) The organization state information selecting unit 342 associates the organization identifier of interest, the i^{th} item identifier, and the first type organization state information with each other.

(Step S1806) The organization state information selecting unit 342 increments the counter i by 1. Processing returns to step S1802.

(Step S1807) The organization state information selecting unit 342 substitutes 1 for the counter j.

(Step S1808) The organization state information selecting unit 342 determines whether or not the j^{th} sector identifier paired with the organization identifier of interest is present. If the j^{th} sector identifier is present, processing proceeds to step S1809, and if the j^{th} sector identifier is not present, processing proceeds to step S1816. Note that the correspondence between the organization identifier, one or more sector identifiers, and one or more member identifiers is managed in the storage unit 31.

(Step S1809) The organization state information selecting unit 342 substitutes 1 for the counter k.

(Step S1810) The organization state information selecting unit 342 determines whether or not the k^{th} item identifier is present. If the k^{th} item identifier is present, processing proceeds to step S1811, and if the k^{th} item identifier is not present, processing proceeds to step S1815. Note that all the item identifiers are stored in the storage unit 31. Also, it may be considered that whether or not the k^{th} item identifier is present means the same as whether or not the k^{th} item score corresponding to the sector identifier of interest is present in the organization state information storage unit 312.

(Step S1811) The organization state information selecting unit 342 acquires an item score that correspond to the k^{th} item identifier that is paired with the j^{th} sector identifier, from the organization state information storage unit 312.

(Step S1812) The organization state information selecting unit 342 determines whether or not the k^{th} item score acquired in step S1811 satisfies the state selection condition. If the k^{th} item score satisfies the state selection condition, processing proceeds to step S1813, and otherwise processing proceeds to step S1814.

(Step S1813) The organization state information selecting unit 342 associates the j^{th} sector identifier, the k^{th} item identifier, and the second type organization state information with each other.

(Step S1814) The organization state information selecting unit 342 increments the counter k by 1. Processing returns to step S1810.

(Step S1815) The organization state information selecting unit 342 increments the counter j by 1. Processing returns to step S1808.

(Step S1816) The organization state information selecting unit 342 substitutes 1 for the counter l.

(Step S1817) The organization state information selecting unit 342 determines whether or not the l^{th} member identifier paired with the organization identifier of interest is present. If the l^{th} member identifier is present, processing proceeds to step S1818, and if the l^{th} member identifier is not present, processing returns to higher level processing.

(Step S1818) The organization state information selecting unit 342 substitutes 1 for the counter m.

(Step S1819) The organization state information selecting unit 342 determines whether or not the m^{th} item identifier that is paired with the l^{th} member identifier is present. If the m^{th} item identifier is present, processing proceeds to step S1820, and if the m^{th} item identifier is not present, processing proceeds to step S1824. Note that all the item identifiers are stored in the storage unit 31. Also, it may be considered that whether or not the m^{th} item identifier is present means the same as whether or not the m^{th} item score corresponding to the member identifier of interest is present in the organization state information storage unit 312.

(Step S1820) The organization state information selecting unit 342 acquires the item score of the m^{th} item identifier that is paired with the l^{th} member identifier, from the organization state information storage unit 312.

(Step S1821) The organization state information selecting unit 342 determines whether or not the k^{th} item score acquired in step S1820 satisfies the state selection condition. If the k^{th} item score satisfies the state selection condition, processing proceeds to step S1821, and otherwise processing proceeds to step S1823.

(Step S1822) The organization state information selecting unit 342 associates the l^{th} member identifier, the m^{th} item identifier, and the third type organization state information with each other.

(Step S1823) The organization state information selecting unit 342 increments the counter m by 1. Processing returns to step S1819.

(Step S1824) The organization state information selecting unit 342 increments the counter l by 1. Processing returns to step S1817.

Next, example of the action information processing in step S1408 will be described with reference to the flowchart shown in FIG. 19.

(Step S1901) The statistical processing unit 343 substitutes 1 for the counter i.

(Step S1902) The statistical processing unit 343 determines whether or not the i^{th} organization identifier is present in the storage unit 31. If the i^{th} organization identifier is present, processing proceeds to step S1903, and otherwise processing returns to higher level processing. Note that whether or not the i^{th} organization identifier is present means the same as whether or not the i^{th} organization on which action information processing is to be performed is present.

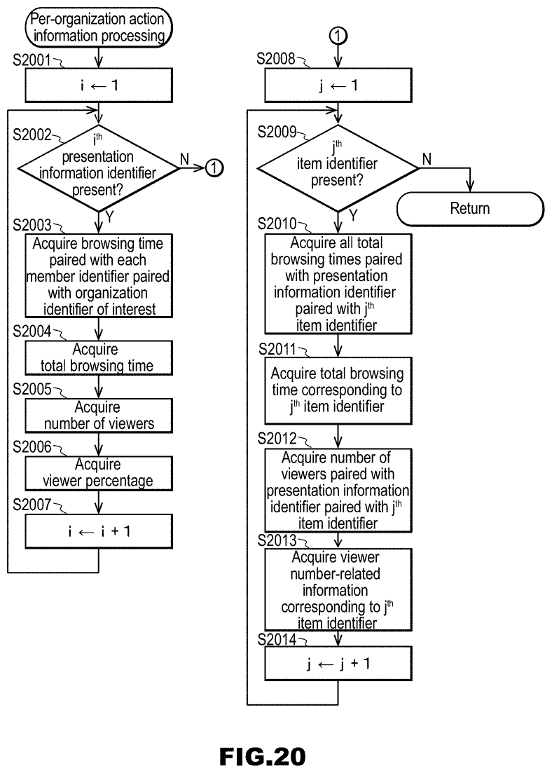

(Step S1903) The statistical processing unit 343 performs per-organization action information processing. Per-organization action information processing is statistical processing that is performed on action information regarding each organization. An example of per-organization action information processing will be described with reference to the flowchart shown in FIG. 20. Note that the per-organization action information processing here is statistical processing that is performed on the action information regarding the organization identified by the i^{th} organization identifier.

(Step S1904) The statistical processing unit 343 substitutes 1 for the counter j.

(Step S1905) The statistical processing unit 343 determines whether or not the j^{th} sector identifier that is paired with the i^{th} organization identifier is present in the storage unit 31. If the j^{th} sector identifier is present, processing proceeds to step S1906, and otherwise processing proceeds to step S1912. Note that whether or not the j^{th} sector identifier is present means the same as whether or not the j^{th} sector on which action information processing is to be performed is present.

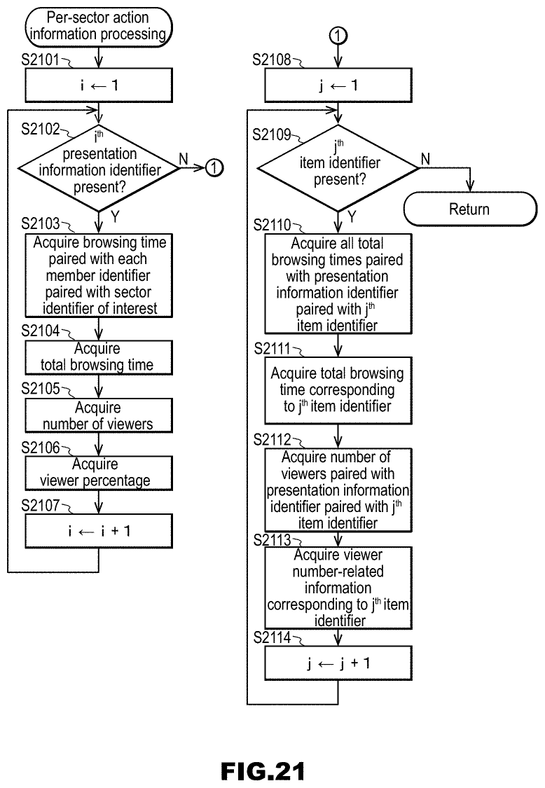

(Step S1906) The statistical processing unit 343 performs per-sector action information processing. Per-sector action information processing is statistical processing that is performed on action information regarding each sector. An example of per-sector action information processing will be described with reference to the flowchart shown in FIG. 21. Note that the per-sector action information processing here is statistical processing that is performed on the action information regarding the sector identified by the j^{th} sector identifier.

(Step S1907) The statistical processing unit 343 substitutes 1 for the counter k.

(Step S1908) The statistical processing unit 343 determines whether or not the k^{th} member identifier that is paired with the j^{th} sector identifier is present in the storage unit 31. If the k^{th} member identifier is present, processing proceeds to step S1909, and otherwise processing proceeds to step S1912. Note that whether or not the k^{th} sector identifier is present means the same as whether or not the k^{th} member on which action information processing is to be performed is present.

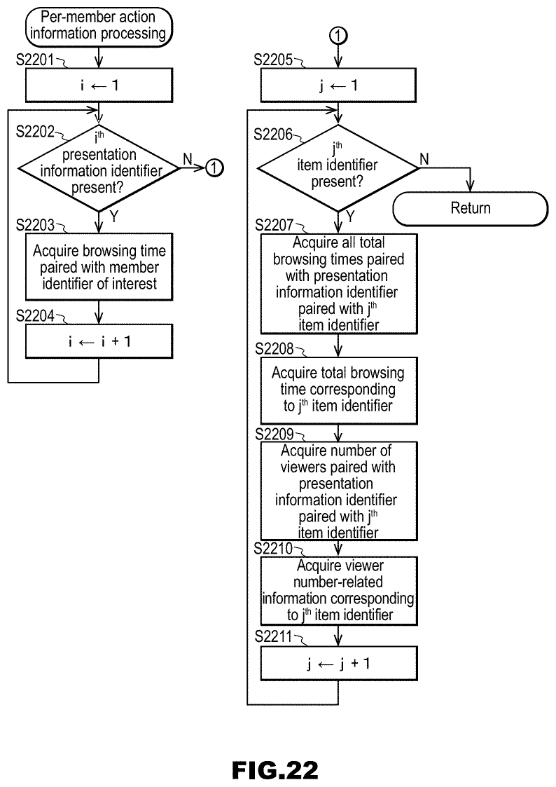

(Step S1909) The statistical processing unit 343 performs per-member action information processing. Per-member action information processing is statistical processing that is performed on action information regarding each member. An example of per-member action information processing will be described with reference to the flowchart shown in FIG. 22. Note that the per-member action information processing here is statistical processing that is performed on the action information regarding the member identified by the k^{th} member identifier.

(Step S1910) The statistical processing unit 343 increments the counter k by 1. Processing returns to step S1908.

(Step S1911) The statistical processing unit 343 increments the counter j by 1. Processing returns to step S1905.

(Step S1912) The statistical processing unit 343 increments the counter i by 1. Processing returns to step S1902.

Next, example of the per-organization action information processing in step S1903 will be described with reference to the flowchart shown in FIG. 20.

(Step S2001) The statistical processing unit 343 substitutes 1 for the counter i.

(Step S2002) The statistical processing unit 343 determines whether or not the i^{th} presentation information identifier is present in the storage unit 311.

If the i^{th} presentation information identifier is present, processing proceeds to step S2003, and if the i^{th} presentation information identifier is not present, processing proceeds to step S2008.

(Step S2003) The statistical processing unit 343 acquires one or more member identifiers that are paired with the organization identifier of interest, from the storage unit 31. Thereafter, the statistical processing unit 343 acquires a browsing time that is paired with one or more member identifiers and is paired with the i^{th} presentation information identifier.

(Step S2004) The statistical processing unit 343 acquires the total browsing time that is the sum of the browsing times paired with the one or more member identifiers acquired in step S2003, and accumulates the total browsing time in association with the organization identifier of interest and the i^{th} presentation information identifier.

(Step S2005) The statistical processing unit 343 acquires the number of member identifiers that are one or more member identifiers that are paired with the organization identifier of interest and are stored in association with a browsing time that is larger than a threshold value (for example, “0” or “10 seconds”). This number is the number of viewers of the presentation information identified by the i^{th} presentation information identifier. Also, the statistical processing unit 343 accumulates the number of viewers in association with the organization identifier of interest and the i^{th} presentation information identifier.

(Step S2006) The statistical processing unit 343 calculates “the number of viewers acquired in step S2005 divided by the number of one or more member identifiers that are paired with the organization identifier of interest” to acquire a viewer percentage. The statistical processing unit 343 accumulates the viewer percentage in association with the organization identifier of interest and the i^{th} presentation information identifier.

(Step S2007) The statistical processing unit 343 increments the counter i by 1. Processing returns to step S2002.

(Step S2008) The statistical processing unit 343 substitutes 1 for the counter j.

(Step S2009) The statistical processing unit 343 determines whether or not the j^{th} item identifier is present in the storage unit 31. If the j^{th} item identifier is present, processing proceeds to step S2010, and if the j^{th} item identifier is not present, processing returns to higher level processing.

(Step S2010) The statistical processing unit 343 acquires one or more presentation information identifiers that are paired with the j^{th} item identifier, from the presentation information storage unit 311. Next, the statistical processing unit 343 acquires the total browsing time that is paired with one or more presentation information identifiers and has been acquired in step S2004.

(Step S2011) The statistical processing unit 343 calculates the sum of the total browsing times paired with the one or more presentation information identifiers acquired in step S2010. Such a sum of the total browsing times is the total browsing time corresponding to the item identified by the j^{th} item identifier. Thereafter, the statistical processing unit 343 accumulates the total browsing time in association with the organization identifier of interest and the j^{th} item identifier.

(Step S2012) For example, the statistical processing unit 343 acquires the number of viewers that is the number of viewers paired with the one or more presentation information identifiers acquired in step S2010, and has been acquired in step S2005. Note that the statistical processing unit 343 here may acquire the one or more member identifiers that are paired with the organization identifier of interest and for which the browsing time paired with the one or more presentation information identifiers paired with the j^{th} item identifier is larger than the threshold value (for example “0” or “10 seconds”) for each presentation information identifier.

(Step S2013) For example, the statistical processing unit 343 calculates the sum of the number of viewers (total number of viewers) acquired in step S2012. For example, the statistical processing unit 343 may perform unique processing on the member identifiers for each of the presentation information identifier acquired in step S2012, and acquire the number of viewers that is the number of member identifiers resulting from the unique processing. The statistical processing unit 343 may acquire the number of viewers that have browsed any piece of the presentation information paired with the j^{th} item identifier. Thereafter, the statistical processing unit 343 accumulates viewer number-related information in association with the organization identifier of interest and the j^{th} item identifier. Note that viewer number-related information is the total number of viewers or the number of viewers that is the number of member identifiers resulting from unique processing.

(Step S2014) The statistical processing unit 343 increments the counter j by 1. Processing returns to step S2009.

Next, example of the per-sector action information processing in step S1906 will be described with reference to the flowchart shown in FIG. 21.

(Step S2101) The statistical processing unit 343 substitutes 1 for the counter i.

(Step S2102) The statistical processing unit 343 determines whether or not the i^{th} presentation information identifier is present in the storage unit 311. If the i^{th} presentation information identifier is present, processing proceeds to step S2103, and if the i^{th} presentation information identifier is not present, processing proceeds to step S2108.

(Step S2103) The statistical processing unit 343 acquires one or more member identifiers that are paired with the sector identifier of interest, from the storage unit 31. Thereafter, the statistical processing unit 343 acquires a browsing time that is paired with one or more member identifiers and is paired with the i^{th} presentation information identifier.

(Step S2104) The statistical processing unit 343 acquires the total browsing time that is the sum of the browsing times paired with the one or more member identifiers acquired in step S2103. Also, the statistical processing unit 343 accumulates the total browsing time in association with the sector identifier of interest and the i^{th} presentation information identifier.

(Step S2105) The statistical processing unit 343 acquires the number of member identifiers that are one or more member identifiers that are paired with the sector identifier of interest and are stored in association with a browsing time that is larger than a threshold value (for example, “0” or “10 seconds”). This number is the number of viewers of the presentation information identified by the i^{th} presentation information identifier. Also, the statistical processing unit 343 accumulates the number of viewers in association with the sector identifier of interest and the i^{th} presentation information identifier.

(Step S2106) The statistical processing unit 343 calculates “the number of viewers acquired in step S2105 divided by the number of one or more member identifiers that are paired with the sector identifier of interest” to acquire a viewer percentage. Also, the statistical processing unit 343 accumulates the number of viewers in association with the sector identifier of interest and the i^{th} presentation information identifier.

(Step S2107) The statistical processing unit 343 increments the counter i by 1. Processing returns to step S2102.

(Step S2108) The statistical processing unit 343 substitutes 1 for the counter j.

(Step S2109) The statistical processing unit 343 determines whether or not the j^{th} item identifier is present in the storage unit 31. If the j^{th} item identifier is present, processing proceeds to step S2110, and if the j^{th} item identifier is not present, processing returns to higher level processing.

(Step S2110) The statistical processing unit 343 acquires one or more presentation information identifiers that are paired with the j^{th} item identifier, from the presentation information storage unit 311. Next, the statistical processing unit 343 acquires the total browsing time that is paired with one or more presentation information identifiers and has been acquired in step S2104.

(Step S2111) The statistical processing unit 343 calculates the sum of the total browsing times paired with the one or more presentation information identifiers acquired in step S2110, and accumulates the sum in the storage unit 31 or a buffer (not shown), in pair with the j^{th} item identifier. Such a sum of the total browsing times is the total browsing time corresponding to the item identified by the j^{th} item identifier. Also, the statistical processing unit 343 accumulates the total browsing time in association with the sector identifier of interest and the i^{th} item identifier.

(Step S2112) For example, the statistical processing unit 343 acquires the number of viewers that is the number of viewers paired with the one or more presentation information identifiers acquired in step S2010, and has been acquired in step S2105. Note that the statistical processing unit 343 here may acquire the one or more member identifiers that are paired with the sector identifier of interest and for which the browsing time paired with the one or more presentation information identifiers paired with the j^{th} item identifier is larger than the threshold value (for example “0” or “10 seconds”) for each presentation information identifier.

(Step S2113) For example, the statistical processing unit 343 calculates the sum of the number of viewers (total number of viewers) acquired in step S2112. For example, the statistical processing unit 343 may acquire OR of the member identifiers of the presentation information identifiers acquired instep S2112 to acquire the number of viewers that have browsed any piece of the presentation information paired with the j^{th} item identifier. Also, the statistical processing unit 343 accumulates the view number-related information in association with the sector identifier of interest and the i^{th} item identifier. Note that the view number-related information is the total number of viewers or the number of viewers calculated by acquiring OR of the member identifiers.

(Step S2114) The statistical processing unit 343 increments the counter j by 1. Processing returns to step S2109.

Next, example of the per-sector action information processing in step S1909 will be described with reference to the flowchart shown in FIG. 22.

(Step S2201) The statistical processing unit 343 substitutes 1 for the counter i.

(Step S2202) The statistical processing unit 343 determines whether or not the i^{th} presentation information identifier is present in the storage unit 311. If the i^{th} presentation information identifier is present, processing proceeds to step S2203, and if the i^{th} presentation information identifier is not present, processing proceeds to step S2205.

(Step S2203) The statistical processing unit 343 acquires a browsing time that is paired with the member identifier of interest and is paired with the i^{th} presentation information identifier.

(Step S2204) The statistical processing unit 343 increments the counter i by 1. Processing returns to step S2202.

(Step S2205) The statistical processing unit 343 substitutes 1 for the counter j.

(Step S2206) The statistical processing unit 343 determines whether or not the j^{th} item identifier is present in the storage unit 31. If the j^{th} item identifier is present, processing proceeds to step S2207, and if the j^{th} item identifier is not present, processing returns to higher level processing.

(Step S2207) The statistical processing unit 343 acquires one or more presentation information identifiers that are paired with the j^{th} item identifier, from the presentation information storage unit 311. Next, the statistical processing unit 343 acquires the browsing time that is paired with the one or more presentation information identifiers, from among the browsing times acquired in step S2203.

(Step S2208) The statistical processing unit 343 calculates the sum of the browsing times paired with the one or more presentation information identifiers acquired in step S2207, and accumulates the total browsing time in pair with the member identifier of interest and the j^{th} item identifier.

(Step S2209) The statistical processing unit 343 acquires the number of presentation information identifiers for which browsing times that are paired with the member identifier of interest and are paired with the one or more presentation information identifiers acquired in step S2207 are larger than a threshold value (for example, “0” or “10 seconds”). This number is the number (view number) of pieces of presentation information that are used to improve the item identified by the j^{th} item identifier and that have been browsed by the member identified by the member identifier of interest. Thereafter, the statistical processing unit 343 accumulates the number of views in association with the member identifier of interest and the j^{th} item identifier.

(Step S2210) For example, the statistical processing unit 343 searches the presentation information storage unit 311 for pieces of presentation information that are paired with the j^{th} item identifier, and acquires the number of pieces thus found. Next, for example, the statistical processing unit 343 acquires view number-related information that is “the number of views acquired in step S2209 divided by the number of hits”, and accumulates the view number-related information in association with the member identifier of interest and the j^{th} item identifier. In such a case, the view number-related information is the percentage of the presentation information viewed by the member identified by the member identifier to improve the item identified by the j^{th} item identifier. Note that the view number-related information may be the number of views acquired in step S2209.

(Step S2211) The statistical processing unit 343 increments the counter j by 1. Processing returns to step S2206.

Next, an example of the change information acquisition processing in step S1410 will be described with reference to the flowchart shown in FIG. 23.

(Step S2301) The change information acquiring unit 345 substitutes 1 for the counter i.

(Step S2302) The change information acquiring unit 345 determines whether or not the i^{th} organization identifier is present in the storage unit 31. If the i^{th} organization identifier is present, processing proceeds to step S2303, and otherwise processing returns to higher level processing. Note that whether or not the i^{th} organization identifier is present means the same as whether or not the i^{th} organization for which change information is to be acquired is present.

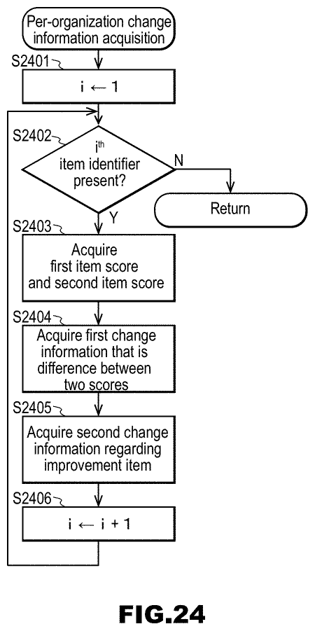

(Step S2303) The change information acquiring unit 345 performs per-organization change information acquisition processing. Per-organization change information acquisition processing is processing that is performed to acquire change information for each organization. Per-organization change information acquisition processing will be described with reference to the flowchart shown in FIG. 24.

(Step S2304) The change information acquiring unit 345 substitutes 1 for the counter j.

(Step S2305) The change information acquiring unit 345 determines whether or not the j^{th} sector identifier is present in the storage unit 31. If the j^{th} sector identifier is present, processing proceeds to step S2306, and otherwise processing proceeds to step S2312. Note that whether or not the j^{th} sector identifier is present means the same as whether or not the j^{th} sector for which change information is to be acquired is present.

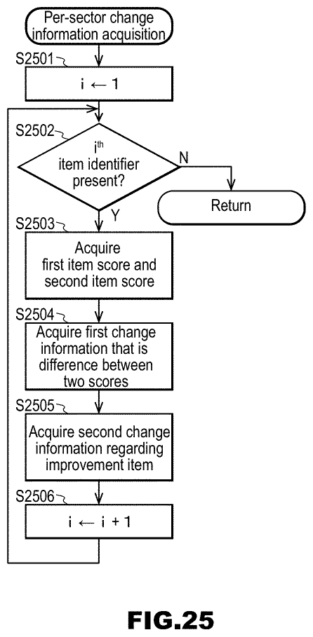

(Step S2306) The change information acquiring unit 345 performs per-organization change information acquisition processing. Per-organization change information acquisition processing is processing that is performed to acquire change information for each sector. Per-sector change information acquisition processing will be described with reference to the flowchart shown in FIG. 25.

(Step S2307) The change information acquiring unit 345 substitutes 1 for the counter k.

(Step S2308) The change information acquiring unit 345 determines whether or not the k^{th} member identifier is present in the storage unit 31. If the k^{th} member identifier is present, processing proceeds to step S2306, and otherwise processing proceeds to step S2312. Note that whether or not the k^{th} member identifier is present means the same as whether or not the k^{th} member on which change information acquisition processing is to be performed is present.

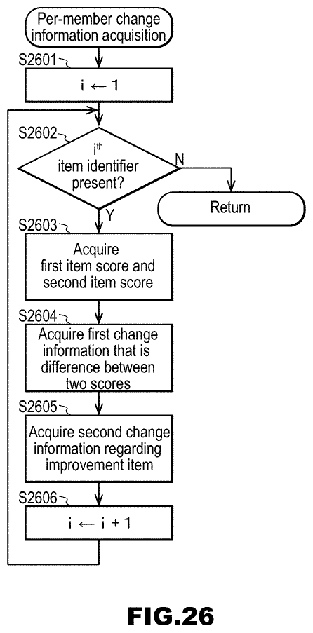

(Step S2309) The change information acquiring unit 345 performs per-member change information acquisition processing. Per-member change information acquisition processing is processing that is performed to acquire change information for each member. Per-member change information acquisition processing will be described with reference to the flowchart shown in FIG. 26.

(Step S2310) The change information acquiring unit 345 increments the counter k by 1. Processing returns to step S2308.

(Step S2311) The change information acquiring unit 345 increments the counter j by 1. Processing returns to step S2305.

(Step S2312) The change information acquiring unit 345 increments the counter i by 1. Processing returns to step S2302.

Next, the per-organization change information acquisition processing in step S2303 will be described with reference to the flowchart shown in FIG. 24.

(Step S2401) The change information acquiring unit 345 substitutes 1 for the counter i.

(Step S2402) The change information acquiring unit 345 determines whether or not the i^{th} item identifier is present. If the i^{th} item identifier is present, processing proceeds to step S2403, and if the i^{th} item identifier is not present, processing proceeds to step S2404.

(Step S2403) The change information acquiring unit 345 acquires a first item score that is an item score paired with the organization identifier of interest and is an item score paired with the i^{th} item identifier, as of a first point in time, from the organization state information storage unit 312. Also, the change information acquiring unit 345 acquires a second item score that is an item score paired with the organization identifier of interest and is an item score paired with the i^{th} item identifier, as of a second point in time, from the organization state information storage unit 312. Note that, for example, the second point in time is the latest point in time, and the first point in time is the previous point in time to the latest point in time.

(Step S2404) The change information acquiring unit 345 acquires first change information that is the difference between the first item score and the second item score acquired in step S2403, and accumulates the first change information in the storage unit 31 in association with the organization identifier of interest and the i^{th} item identifier.

(Step S2405) The change information acquiring unit 345 acquires second change information that is information regarding the improvement item, using the first item score and the second item score acquired in step S2403, and accumulates the second change information in the storage unit 31 in association with the organization identifier of interest and the i^{th} item identifier.

Note that the second change information is information that indicates, for example, “an item that was an improvement item at the first point in time has become a non-improvement item at the second point in time as a result of improvement”, “an item that was an improvement item at the first point in time is an improvement item at the second point in time”, “an item that was non-improvement item at the first point im time is a non-improvement item at the second point in time”, or “an item that was a non-improvement item at the first point in time has become an improvement item at the second point in time as a result of improvement”.

For example, the change information acquiring unit 345 determines whether or not the first item score satisfies the state selection condition stored in the storage unit 31, and if the first item score satisfies the state selection condition, the change information acquiring unit 345 determines that the item identified by the i^{th} item identifier is an improvement item at the first point in time, and if the first item score does not satisfy the state selection condition, the change information acquiring unit 345 determines that the item identified by the i^{th} item identifier is an non-improvement item at the first point in time. Also, for example, the change information acquiring unit 345 determines whether or not the second item score satisfies the state selection condition stored in the storage unit 31, and if the second item score satisfies the state selection condition, the change information acquiring unit 345 determines that the item identified by the i^{th} item identifier is an improvement item at the second point in time, and if the second item score does not satisfy the state selection condition, the change information acquiring unit 345 determines that the item identified by the i^{th} item identifier is an non-improvement item at the second point in time.

(Step S2406) The change information acquiring unit 345 increments the counter i by 1. Processing returns to step S2302.

Next, the per-sector change information acquisition processing in step S2306 will be described with reference to the flowchart shown in FIG. 25.

(Step S2501) The change information acquiring unit 345 substitutes 1 for the counter i.

(Step S2502) The change information acquiring unit 345 determines whether or not the i^{th} item identifier is present. If the i^{th} item identifier is present, processing proceeds to step S2503, and if the i^{th} item identifier is not present, processing proceeds to step S2504.

(Step S2503) The change information acquiring unit 345 acquires a first item score that is an item score paired with the sector identifier of interest and is an item score paired with the i^{th} item identifier, as of a first point in time, from the organization state information storage unit 312. Also, the change information acquiring unit 345 acquires a second item score that is an item score paired with the sector identifier of interest and is an item score paired with the i^{th} item identifier, as of a second point in time, from the organization state information storage unit 312. Note that, for example, the second point in time is the latest point in time, and the first point in time is the previous point in time to the latest point in time.

(Step S2504) The change information acquiring unit 345 acquires first change information that is the difference between the first item score and the second item score acquired in step S2503, and accumulates the first change information in association with the sector identifier of interest and the i^{th} item identifier.

(Step S2505) The change information acquiring unit 345 acquires second change information that is information regarding the improvement item, using the first item score and the second item score acquired in step S2503, and accumulates the second change information in association with the sector identifier of interest and the i^{th} item identifier. Note that the example of the method for acquiring the second change information is as described above.

(Step S2506) The change information acquiring unit 345 increments the counter i by 1. Processing returns to step S2302.

Next, the per-member change information acquisition processing in step S2309 will be described with reference to the flowchart shown in FIG. 26.

(Step S2601) The change information acquiring unit 345 substitutes 1 for the counter i.

(Step S2602) The change information acquiring unit 345 determines whether or not the i^{th} item identifier is present. If the i^{th} item identifier is present, processing proceeds to step S2603, and if the i^{th} item identifier is not present, processing proceeds to step S2604.

(Step S2603) The change information acquiring unit 345 acquires a first item score that is an item score paired with the member identifier of interest and is an item score paired with the i^{th} item identifier, as of a first point in time, from the organization state information storage unit 312. Also, the change information acquiring unit 345 acquires a second item score that is an item score paired with the member identifier of interest and is an item score paired with the i^{th} item identifier, as of a second point in time, from the organization state information storage unit 312. Note that, for example, the second point in time is the latest point in time, and the first point in time is the previous point in time to the latest point in time.

(Step S2604) The change information acquiring unit 345 acquires first change information that is the difference between the first item score and the second item score acquired in step S2603, and accumulates the first change information in association with the member identifier of interest and the i^{th} item identifier.

(Step S2605) The change information acquiring unit 345 acquires second change information that is information regarding the improvement item, using the first item score and the second item score acquired in step S2603, and accumulates the second change information in association with the member identifier of interest and the i^{th} item identifier. Note that the example of the method for acquiring the second change information is as described above.

(Step S2606) The change information acquiring unit 345 increments the counter i by 1. Processing returns to step S2302.

Next, a second example of the output information acquisition processing in step S1402 will be described with reference to the flowchart shown in FIG. 27.

(Step S2701) The output information acquiring unit 344 acquires screen information regarding a screen that is used to select the target to be improved (an organization, a sector, or a member). Note that screen information is stored in the storage unit 31, for example. Note that screen information is information regarding a screen for selecting an organization, a sector, or a member.

(Step S2702) The output unit 35 transmits the screen information acquired in step S2701 to a management terminal 5.

(Step S2703) The receiving unit 33 receives the result of selection of an item identifier from the management terminal 5. The reselection result includes one or more pieces of information of: an organization identifier; a sector identifier; and a member identifier, for example.

(Step S2704) The output information acquiring unit 344 determines whether or not the selection result received in step S2703 includes information that specifies an organization (an organization identifier in this example). If information that specifies an organization is included, processing proceeds to step S2705, and otherwise processing proceeds to step S2710.

(Step S2705) The output information acquiring unit 344 acquires one or more pieces of item information that include an item identifier and an item score that are paired with the organization identifier included in the selection result, from the organization state information selecting unit 342.

(Step S2706) The output information acquiring unit 344 forms screen information that is information regarding a screen that includes the one or more pieces of item information acquired in step S2705, and is information regarding a screen that is used to select an item identifier as an improvement item.

For example, the output information acquiring unit 344 inserts a selection object that includes the one or more pieces of item information acquired in step S2705 into a screen information template that is stored in the storage unit 31, to acquire screen information. The selection object in this example is an object that can be used to select an item identifier, and is, for example, a user interface component that includes a check box, a menu item, or the like.

(Step S2707) The output unit 35 transmits the screen information formed in step S2706 to a management terminal 5, for example.

(Step S2708) The receiving unit 33 receives the result of selection of an item identifier from the management terminal 5. The reselection result in this example is information that specifies one or more pieces of item information, and typically includes one or more item identifiers.

(Step S2709) The output information acquiring unit 344 accumulates the one or more item identifiers included in the selection result received in step S2708, in pair with the organization identifier included in the selection result received in step S2703. Note that the one or more item identifiers are pieces of information that identify the improvement items of the organization.

(Step S2710) The output information acquiring unit 344 determines whether or not the selection result received in step S2703 includes information that specifies a sector (a sector identifier in this example). If information that specifies a sector is included, processing proceeds to step S2711, and otherwise processing proceeds to step S2716.

(Step S2711) The output information acquiring unit 344 acquires one or more pieces of item information that include an item identifier and an item score that are paired with the sector identifier included in the selection result, from the organization state information selecting unit 342.

(Step S2712) The output information acquiring unit 344 forms screen information that is information regarding a screen that includes the one or more pieces of item information acquired in step S2711, and is information regarding a screen that is to be used to select an item identifier as an improvement item.

(Step S2713) The output unit 35 transmits the screen information formed in step S2712 to the management terminal 5, for example.

(Step S2714) The receiving unit 33 receives the result of selection of an item identifier from the management terminal 5. The reselection result in this example typically includes one or more item identifiers.

(Step S2715) The output information acquiring unit 344 accumulates the one or more item identifiers included in the selection result received in step S2714, in pair with the sector identifier included in the selection result received in step S2703. Note that the one or more item identifiers are pieces of information that identify the improvement items of the sector.

(Step S2716) The output information acquiring unit 344 determines whether or not the selection result received in step S2703 includes information that specifies a member (a member identifier in this example). If information that specifies a member is included, processing proceeds to step S2717, and otherwise processing returns to higher level processing.

(Step S2717) The output information acquiring unit 344 acquires one or more pieces of item information that include an item identifier and an item score that are paired with the member identifier included in the selection result, from the organization state information selecting unit 342.

(Step S2718) The output information acquiring unit 344 forms screen information that is information regarding a screen that includes the one or more pieces of item information acquired in step S2717, and is information regarding a screen that is to be used to select an item identifier as an improvement item.

(Step S2719) The output unit 35 transmits the screen information formed in step S2718 to the management terminal 5, for example.

(Step S2720) The receiving unit 33 receives the result of selection of an item identifier from the management terminal 5. The reselection result in this example typically includes one or more item identifiers.

(Step S2721) The output information acquiring unit 344 accumulates the one or more item identifiers included in the selection result received in step S2720, in pair with the member identifier included in the selection result received in step S2703. Processing proceeds to step S1602 shown in FIG. 16, and the processing in step S1602 and the subsequent steps will be performed. Note that the one or more item identifiers are pieces of information that identify the improvement items of the member.

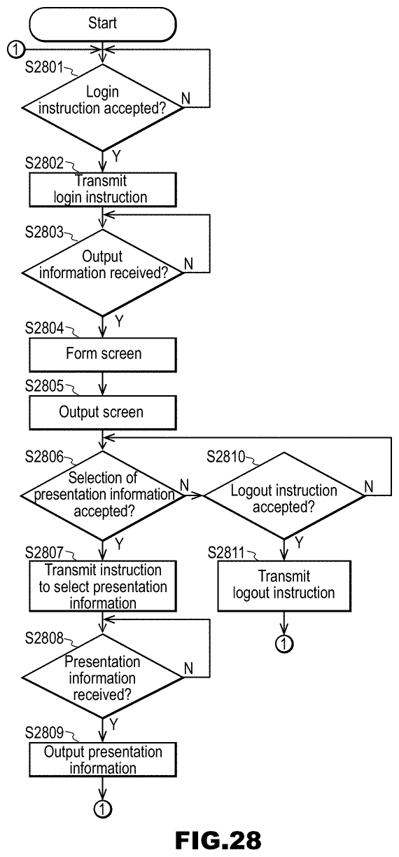

Next, examples of operations of each terminal apparatus 4 will be described with reference to the flowchart shown in FIG. 28.

(Step S2801) The terminal accepting unit 42 determines whether or not a login instruction has been accepted. If a login instruction has been accepted, processing proceeds to step S2802, and if a login instruction has not been accepted, processing returns to step S2801. Note that a login instruction includes a member identifier, for example.

(Step S2802) The terminal transmitting unit 44 transmits the login instruction accepted in step S2801 to the information processing apparatus 3.

(Step S2803) The terminal receiving unit 45 determines whether or not output information has been received from the information processing apparatus 3 upon the login instruction being transmitted in step S2802. If output information has been received, processing proceeds to step S2804, and if output information has not been received, processing proceeds to step S2803.

(Step S2804) The terminal processing unit 43 forms a screen that is used to select presentation information, using the output information received in step S2803.

(Step S2805) The terminal output unit 46 outputs the screen formed in step S2804.

(Step S2806) The terminal accepting unit 42 determines whether or not a selection of a piece of presentation information of a member has been received from the pieces of presentation information in the output screen. If a selection of presentation information has been accepted, processing proceeds to step S2807, and if a selection of presentation information has not been accepted, processing returns to step S2810. Note that the selection of presentation information includes a presentation information identifier.

(Step S2807) The terminal transmitting unit 44 transmits the selection of presentation information accepted in step S2806 to the information processing apparatus 3.

(Step S2808) The terminal receiving unit 45 determines whether or not presentation information has been received from the information processing apparatus 3 upon the selection of presentation information being transmitted. If presentation information has been received, processing proceeds to step S2809, and if presentation information has not been received, processing proceeds to step S2808.

(Step S2809) The terminal output unit 46 outputs the presentation information received in step S2808. Processing returns to step S2801. Note that the output of presentation information is terminated when an interruption is made to terminate the output.

(Step S2810) The terminal accepting unit 42 determines whether or not a logout instruction has been accepted. If a logout instruction has been accepted, processing proceeds to step S2811, and if a logout instruction has not been accepted, processing returns to step S2806.

(Step S2811) The terminal transmitting unit 44 transmits the logout instruction accepted in step S2810 to the information processing apparatus 3. Processing returns to step S2801.

In the flowchart shown in FIG. 28, processing is terminated when power is turned off or an interruption is made to terminate the processing.

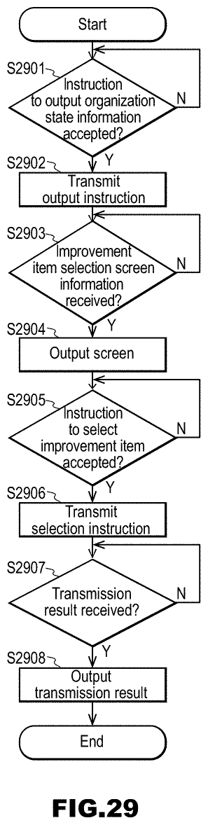

Next, examples of operations of each management terminal 5 will be described with reference to the flowchart shown in FIG. 29.

(Step S2901) The management accepting unit 52 determines whether or not an output instruction regarding organization state information has been accepted. If an output instruction regarding organization state information has been accepted, processing proceeds to step S2902, and if an output instruction regarding organization state information has not been accepted, processing returns to step S2901.

(Step S2902) The management transmitting unit 54 transmits the output instruction accepted in step S2901 to the information processing apparatus 3.

(step S2903) The management receiving unit 55 determines whether or not selection screen information regarding improvement items has been received upon the output instruction being transmitted. If selection screen information regarding improvement items has been received, processing proceeds to step S2904, and if selection screen information regarding improvement items has not been received, processing proceeds to step S2903. Note that selection screen information regarding improvement items is information regarding a screen that includes pieces of item information regarding candidates for improvement items, and from which a piece of item information can be selected. Item information includes, for example, an item identifier and an item score.

(Step S2904) The management output unit 56 outputs a screen using the selection screen information received in step S2903.

(Step S2905) The management accepting unit 52 determines whether or not an instruction to select an improvement item has been accepted from the administrator on the screen output in step S2904. If an instruction to select an improvement item has been accepted, processing proceeds to step S2906, and if an instruction to select an improvement item has not been accepted, processing proceeds to step S2905. Note that an instruction to select an improvement item includes one or more item identifiers corresponding to the improvement item. Also, an instruction to select an improvement item typically includes an organization identifier and one or more item identifiers, or a sector identifier and one or more item identifiers, or a member identifier and one or more item identifiers.

(Step S2906) The management transmitting unit 54 transmits the instruction to select an improvement item accepted in step S2905 to the information processing apparatus 3. Note that an instruction to select an improvement item include one or more kinds of information of: an organization identifier and one or more item identifiers; a sector identifier and one or more item identifiers; and a member identifier and one or more item identifiers. In the information processing apparatus 3, as a result of such an instruction to select an improvement item being transmitted, one or more kinds of information of: an organization identifier and one or more item identifiers; a sector identifier and one or more item identifiers; and a member identifier and one or more item identifiers are accumulated in the organization state information storage unit 312 as state information.

(Step S2907) The management receiving unit 55 determines whether or not a transmission result has been received upon the instruction to select an improvement item being transmitted in step S2906. If a transmission result has been received, processing proceeds to step S2908, and if a transmission result has not been received, processing proceeds to step S2907.

(Step S2908) The management output unit 56 outputs the transmission result received in step S2907. Processing is terminated. Note that the transmission result is information indicating that an improvement item corresponding to one of: an organization; a sector; and a member has been registered.

In the flowchart shown in FIG. 29, processing is terminated when power is turned off or an interruption is made to terminate the processing.

The following describes specific operations that are performed by the information system B according to the present embodiment. A conceptual diagram for the information system B is FIG. 11. Note that the attribute value “−” in each table indicates NULL.

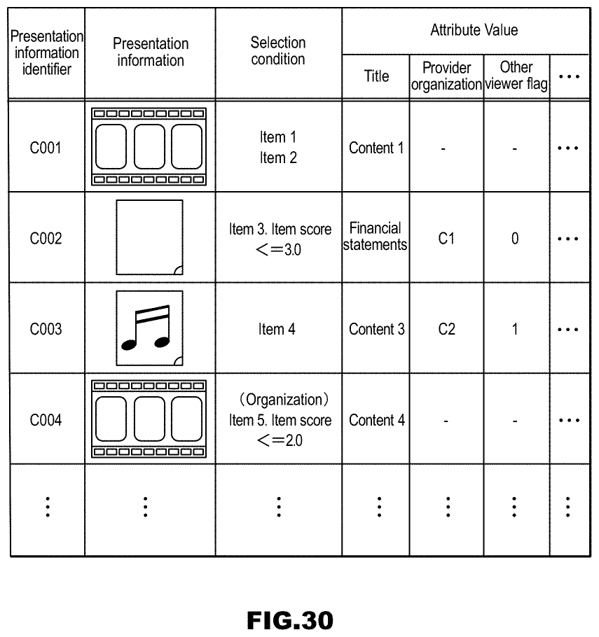

Now, the presentation information storage unit 311 stores the presentation information management table shown in FIG. 30. The presentation information management table is a table in which presentation information is managed. The presentation information management table includes “presentation information identifier”, “presentation information”, “selection condition”, and “attribute value”. Here, “presentation information” is, for example, a moving image, a text file, audio information, a still image, or the like. Presentation information with a presentation information identifier “C001” or “C004” is a moving image. Presentation information with a presentation information identifier “C002” is a text file. Presentation information with a presentation information identifier “C003” is audio information. “Selection condition” is a condition related to one or more item identifiers that specify improvement items or an item score. “Attribute value” includes “tile”, “provider organization”, and “other viewer flag”. “Title” is the tile of “presentation information”. “Provider organization” is an organization identifier that identifies the organization that provides “presentation information”. When “provider organization” is “−” (empty), “presentation information” is content prepared by the provider organization of the information processing apparatus 3, and there is no viewing restriction here. “Other viewer flag” is a flag indicating whether or not to allow other organizations to browse information when a “provider organization” is present. In this example, when “other viewer flag=0”, other organizations are not allowed to browse information, and when “other viewer flag=1”, other organizations are allowed to browse information. That is, presentation information “C003” of the organization identified by the organization identifier “C2” indicates that the members of organizations other than the organization identified by the organization identifier “C2” cannot browse information.

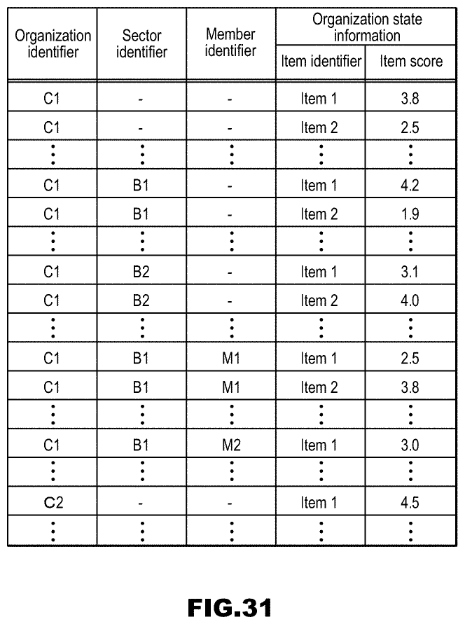

The organization state information storage unit 312 stores a first organization state information management table shown in FIG. 31. The first organization state information management table is a table that includes one or more records that each include “organization identifier”, “sector identifier”, “member identifier”, and “organization state information”. “Sector identifier” and “member identifier” may be “−” (empty). “Organization” in this example is a set consisting of “item identifier” and “item score”. The “item identifier” in FIG. 31 is “item 1”, item 2″, “item 3”, and so on, and “item 1”, item 2″, “item 3”, and so on. are, for example, the attribute values of the “item” in FIG. 6, namely “company satisfaction level”, “job satisfaction level”, “impact in the industry”, “holidays and working hours”, and so on.

In FIG. 31, the item score of the item 1 of the organization identified by the organization identifier “C1” is “3.8”. Also, in FIG. 31, the item score of the item 1 of the sector identified by the sector identifier “B1” of the organization identified by the organization identifier “C1” is “4.2”. Also, in FIG. 31, the item score of the item 1 of the member identifier M1” belonging to the sector identified by the sector identifier “B1” of the organization identified by the organization identifier “C1” is “2.5”.

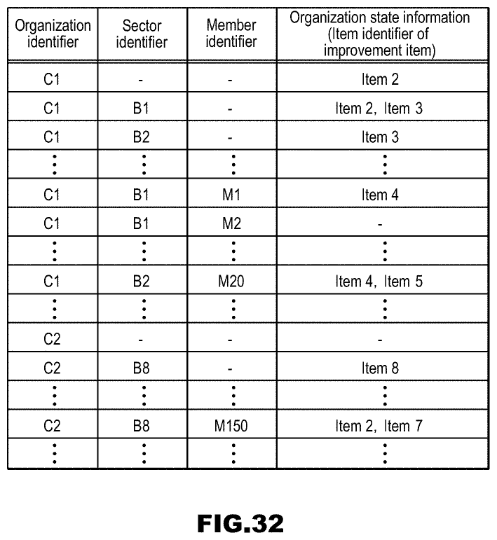

The organization state information storage unit 312 stores a second organization state information management table shown in FIG. 32. The first organization state information management table is a table that includes one or more records that each include “organization identifier”, “sector identifier”, “member identifier”, and “organization state information”. The “organization state information” in the second organization state information management table is one or more item identifiers of improvement items. When no improvement item is present, the attribute value is “−”.

In such a situation, it is assumed that the member identified by the member identifier “M1” inputs a login instruction to their own terminal apparatus 4. Next, the terminal accepting unit 42 of the terminal apparatus 4 accepts the login instruction. Thereafter, the terminal transmitting unit 44 transmits a login instruction that includes a member identifier “M1” to the information processing apparatus 3.

Next, the receiving unit 33 of the information processing apparatus 3 transmits the login instruction that includes the member identifier “M1”. Next, the processing unit 34 performs processing for login. Next, the processing unit 34 determines that it is the time to transmit output information to the terminal apparatus 4.

Next, the output information acquiring unit 344 performs output information acquisition processing as follows.

First, the output information acquiring unit 344 acquires the organization identifier “C1” paired with the member identifier “M1” and the sector identifier “B1” from the storage unit 31. Note that the output information acquiring unit 344 may acquires the organization identifier “C1” paired with the member identifier “M1” and the sector identifier “B1” from the table shown in FIG. 31, from the storage unit 31.

Next, the output information acquiring unit 344 determines whether or not each of the pieces of organization state information paired with the organization identifier “C1”, the sector identifier “−”, and the member identifier “−” in FIG. 31 matches the condition related to the score of the “selection condition” in the presentation information management table in FIG. 30. Thereafter, the output information acquiring unit 344 acquires the presentation information identifier (for example, “C002”) paired with the “selection condition” that the organization state information matches.

Also, the output information acquiring unit 344 acquires the item identifier “item 2” of the improvement item paired with the organization identifier “C1”, from the second organization state information management table. Also, the output information acquiring unit 344 acquires the presentation information identifier “C001” for which the item identifier “item 2” is the selection condition.

Note that, in FIG. 32, even if “item 4” is included in the item identifiers of the improvement items paired with the organization identifier “C1”, the output information acquiring unit 344 does not acquire the presentation information identifier “C003” paired with “item 4”. That is to say, the output information acquiring unit 344 acquires the provider organization “C2” paired with the presentation information identifier “C003” and the other viewer flag “1” in FIG. 30, determines that the members of organizations other than the organization identified by the organization identifier “C2” cannot browse information, and does not acquire the presentation information identifier “C003” for the members identified by the member identifier “M1” paired with the organization identifier “C1”.

Thereafter, the output information acquiring unit 344 accumulates the organization identifier “C1”, the presentation information identifiers “C001” and “C002”, and the first type organization state information in a buffer (not shown) in association with each other.

Next, the output information acquiring unit 344 determines whether or not each of the pieces of organization state information paired with the organization identifier “C1”, the sector identifier “B1”, and the member identifier “−” in FIG. 31 matches the condition related to the score of the “selection condition” in the presentation information management table in FIG. 30. It is assumed that the output information acquiring unit 344 determines that no “selection condition” that matches the organization state information is present.

Also, the output information acquiring unit 344 acquires the item identifiers “item 2” and “item 3” of the improvement items paired with the organization identifier “C1” and the sector identifier “B1”, from the second organization state information management table. Also, the output information acquiring unit 344 acquires the presentation information identifier “C001” for which the item identifiers “item 2” and “item 3” are the selection conditions. Thereafter, the output information acquiring unit 344 accumulates the organization identifier “C1”, the sector identifier “B1”, the presentation information identifier “C001”, and the second type organization state information in a buffer (not shown) in association with each other.

Next, the output information acquiring unit 344 determines whether or not each of the pieces of organization state information paired with the organization identifier “C1”, the sector identifier “B1”, and the member identifier “M1” matches the condition related to the score of the “selection condition” in the presentation information management table in FIG. 30. Thereafter, the output information acquiring unit 344 acquires the presentation information identifier (for example, “C004”) paired with the “selection condition” that the organization state information matches.

Also, the output information acquiring unit 344 acquires the item identifier “item 4” of the improvement item paired with the organization identifier “C1”, the sector identifier “B1”, and the member identifier “M1”, from the second organization state information management table. Also, the output information acquiring unit 344 selects the presentation information identifier “C003” for which the item identifier “item 4” is the selection condition.

Next, the output information acquiring unit 344 acquires the provider organization “C2” paired with the presentation information identifier “C003” and the other viewer flag “1” in FIG. 30, determines that the members of organizations other than the organization identified by the organization identifier “C2” cannot browse information, and ultimately does not acquire the presentation information identifier “C003” for the members identified by the member identifier “M1” paired with the organization identifier “C1”.

Thereafter, the output information acquiring unit 344 accumulates the organization identifier “C1”, the sector identifier “B1”, the member identifier “M1”, the presentation information identifier “C004”, and the third type organization state information in a buffer (not shown) in association with each other.

Next, the output information acquiring unit 344 performs output information forming processing as follows. That is to say, in this example, it is assumed that screen information is formed in which contents are classified into contents that are to be browsed by members belonging to the organization identified by the organization identifier “C1”, contents that are to be browsed by members belonging to the sector identified by the sector identifier “B1” of the organization identified by the organization identifier “C1”, and contents that are to be browsed by the member identified by the member identifier “M1”, and one or more pieces of presentation information are selectable.

Next, the output information transmitting unit 351 transmits output information that is the formed screen information.

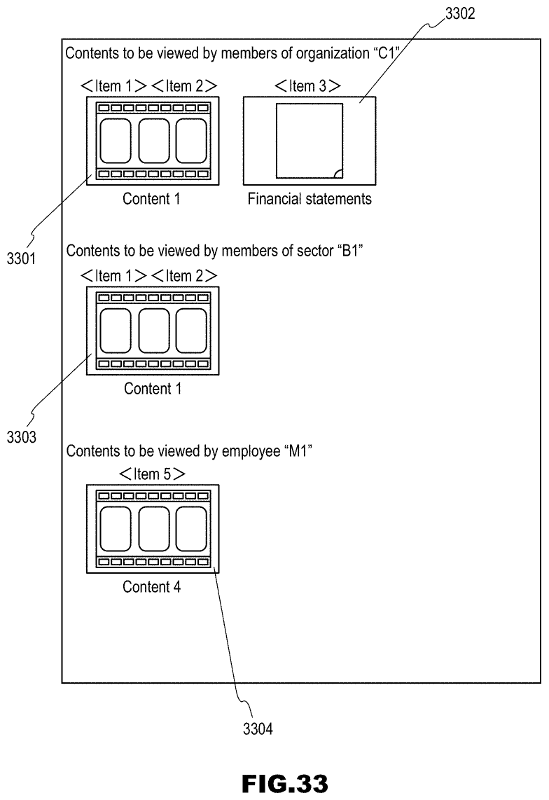

Next, upon a login instruction being transmitted, the terminal receiving unit 45 receives the output information from the information processing apparatus 3. The terminal processing unit 43 forms a screen that is used to select presentation information, using the received output information. Next, the terminal output unit 46 outputs the formed screen. An example of the screen at this time is shown in FIG. 33. In FIGS. 33, 3301 to 3304 indicate selectable buttons.

Next, it is assumed that the user presses the selection button 3303. Accordingly, the terminal accepting unit 42 accepts the selection of presentation information. Next, an instruction that includes the presentation information identifier “C001” corresponding to the selection button 3303 and that is an instruction to select presentation information is transmitted to the information processing apparatus 3.

Next, the information processing apparatus 3 receives the selection instruction and transmits the presentation information paired with the presentation information identifier “C001” to the terminal apparatus 4.

Next, the terminal apparatus 4 receives and outputs the presentation information identified by the presentation information identifier “C001”.

As a result of these operations, the member identified by the member identifier “M1” can browse presentation information that is expected to improve the items 1 and 2.

With the present embodiment, it is possible to appropriately provide the members of an organization with information, using organization state information, in order to improve the organization.

Note that, with the present embodiment, it is possible to appropriately provide the members of an organization with information, using organization state information acquired by analyzing response information regarding a questionnaire directed to the members of the organization, in order to improve the organization.

Also, according to the present embodiment, it is possible to appropriately provide the members of an organization with information, using organization state information selected by a user, in order to improve the organization.

Also, according to the present embodiment, it is possible to appropriately provide the members of an organization with information, using organization state information selected by a user from candidates for organization state information that have automatically been selected, in order to improve the organization.

Also, according to the present embodiment, it is possible to appropriately provide the members of an organization with information, using organization state information that has automatically been selected, in order to improve the organization.

Also, according to the present embodiment, it is possible to perform statistical processing on information regarding actions performed in response to information presented to the members of an organization, and output the statistical processing result.

Also, according to the present embodiment, it is possible to perform statistical processing on information regarding actions performed in response to information presented to the members of an organization, and appropriately provide the members of the organization with information, using the statistical processing result.

Also, according to the present embodiment, it is possible to acquire and output a change in the state of an organization after providing information to the member of an organization, in order to improve the organization.

Also, according to the present embodiment, it is possible to, after providing information to the member of an organization, acquire organization state information acquired by analyzing response information regarding a questionnaire directed to the members of the organization, and acquire and output a change in the organization state information before and after the questionnaire is provided, using organization state information, in order to improve the organization.

Furthermore, according to the present embodiment, it is possible to clarify the range of the statistically processed questionnaire response information on which the information presented to the members of an organization is based.

Furthermore, the processing in the present embodiment may be realized using software. This software may be distributed through software downloading or the like. Also, this software may be recorded on a recording medium such as a CD-ROM and distributed. Note that the same applies to the other embodiments in the present description. The software that realizes the information processing apparatus in the present embodiment is the program described below. That is to say, the program is a program that enables a computer that can access: an organization state information storage unit that stores organization state information that is information regarding a state of an organization; and a presentation information storage unit that stores one or more pieces of presentation information that are pieces of information to be presented to a member of the organization, to function as: an output information acquiring unit that determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, using the organization state information; and an output information transmitting unit that transmits the piece of presentation information determined by the output information acquiring unit or output information that is the presentation information changed by the output information acquiring unit.

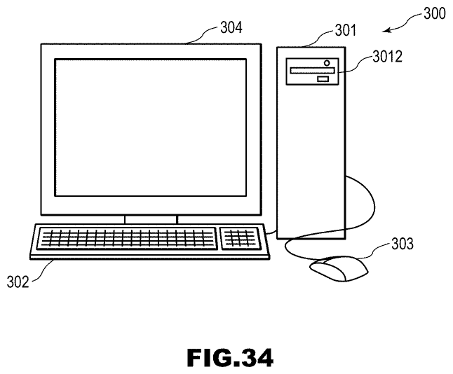

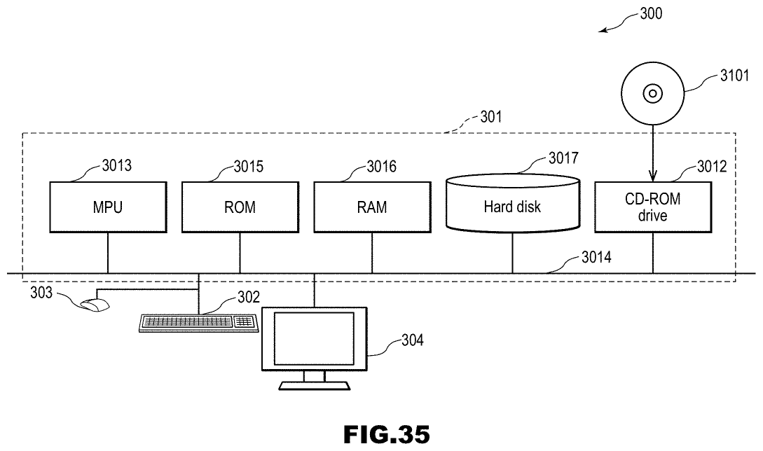

FIG. 34 shows the external appearance of a computer that executes the program described in this specification to realize the information processing apparatus 1 and the so on in the above-described various embodiments. The above-described embodiments may be realized using computer hardware and a computer program executed thereon. FIG. 34 is a schematic view of a computer system 300, and FIG. 35 is a block diagram for the system 300. Note that FIGS. 34 and 35 are diagrams that show an external appearance of a computer that realizes an engagement system.

In FIG. 34, the computer system 300 includes a computer 301 including a CD-ROM drive, a keyboard 302, a mouse 303, and a monitor 304.

In FIG. 35, the computer 301 includes, in addition to the CD-ROM drive 3012, an MPU 3013, a bus 3014 connected to the CD-ROM drive 3012 and the like, a ROM 3015 in which a program such as a boot up program is stored, a RAM 3016 that is connected to the MPU 3013 and is a memory in which a command of an application program is temporarily stored and a temporary storage area is provided, and a hard disk 3017 in which an application program, a system program, and data are stored. Although not shown, the computer 301 may further include a network card that provides connection to a LAN. Although not shown, the computer 301 may further include a network card that provides connection to a LAN. Note that the MPU3013 may be another kind of processor such as a CPU or a GPU.

The program that enables the computer system 300 to execute the functions of the information processing apparatus 1 and so on in the above-described embodiments may be stored in a CD-ROM 3101 that is inserted into the CD-ROM drive 3012, and transmitted to the hard disk 3017. Alternatively, the program may be transmitted via a network (not shown) to the computer 301 and stored in the hard disk 3017. At the time of execution, the program is loaded into the RAM 3016. The program may be loaded from the CD-ROM 3101, or directly from a network.

The program does not necessarily have to include, for example, an operating system (OS) or a third-party program to enable the computer 301 to execute the functions of the information processing apparatus 1 and so on in the above-described embodiments. The program need only include a command portion to call an appropriate function (module) in a controlled mode and obtain desired results. The manner in which the computer system 300 operates is well known, and thus a detailed description thereof is omitted.

Note that, in the program, in a step of transmitting information, a step of receiving information, or the like, processing that is performed by hardware, for example, processing performed by a modem or an interface card in the transmitting step (processing that can be performed only by hardware) is not included.

Also, the computer that executes the program may be a single computer, or may be multiple computers. That is to say, centralized processing may be performed, or distributed processing may be performed.

As a matter of course, in the above-described embodiments, the two or more communication means in one apparatus may be physically realized by one medium.

In the above-described embodiments, each kind of processing may be realized as centralized processing using a single apparatus, or may be realized as distributed processing using multiple apparatuses. That is to say, the information processing apparatus 1 may be a stand-alone apparatus. If the information processing apparatus 1 is a stand-alone apparatus, the accepting unit 12 accepts instructions, information, or the like from users or the like. The output unit 14 outputs information and the like through displaying, sound output, or transmission to a display apparatus.

As a matter of course, the present invention is not limited to the above-described embodiments, and various modifications may be made, and such modifications are also included in the scope of the present invention.

### INDUSTRIAL APPLICABILITY

As described above, an information processing apparatus according to the present invention has the effect of appropriately providing information to members of an organization, using organization state information, in order to improve the organization, and is useful as a server apparatus or the like that realizes engagement.

1. An information processing apparatus comprising:
an organization state information storage unit that stores organization state information regarding a state of an organization;
a presentation information storage unit that stores one or more pieces of presentation information that is to be presented to a member of an organization;
an output information acquiring unit that determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, using the organization state information; and
an output information transmitting unit that transmits the piece of presentation information determined by the output information acquiring unit or output information that is the presentation information changed by the output information acquiring unit.

2. The information processing apparatus according to claim 1, further comprising
an organization state information acquiring unit that analyzes response information regarding a questionnaire directed to one or more members of the organization, to acquire organization state information,
wherein the organization state information in the organization state information storage unit is the organization state information acquired by the organization state information acquiring unit.

3. The information processing apparatus according to claim 2,
wherein the organization state information acquiring unit performs statistical processing on response information regarding an questionnaire directed to two or members of the organization, to acquire organization state information that is an overall statistical processing result of the organization, or performs statistical processing on response information regarding an questionnaire directed to two or more members of a sector to which the two or more members of the organization belong, to acquire organization state information that is a statistical processing result of the sector, or acquires organization state information by using one or more kinds of information included in questionnaire responses from the members.

4. The information processing apparatus according to claim 1,
wherein the organization state information storage unit stores two or more pieces of organization state information,
the information processing apparatus further comprises:
a state-related information output unit that outputs two or more pieces of state-related information regarding the organization state information stored in the organization state information storage unit; and
a selection accepting unit that accepts selection of one or more pieces of state-related information from among the two or more pieces of state-related information output by the state-related information output unit, and
the output information acquiring unit determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, using one or more pieces of state-related information corresponding to the selection accepted by the selection accepting unit.

5. The information processing apparatus according to claim 1,
wherein the organization state information storage unit stores two or more pieces of organization state information,
the information processing apparatus further comprises:
an organization state information selecting unit that selects one or more pieces of organization state information that satisfy a predetermined state selection condition from among the two or more pieces of organization state information;
a state-related information output unit that outputs two or more pieces of state-related information regarding the one or more pieces of organization state information selected by the organization state information selecting unit; and
a selection accepting unit that accepts selection of one or more pieces of state-related information from among the two or more pieces of state-related information output by the state-related information output unit, and
the output information acquiring unit determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, using one or more pieces of state-related information corresponding to the selection accepted by the selection accepting unit.

6. The information processing apparatus according to claim 1,
wherein the organization state information storage unit stores two or more pieces of organization state information,
the information processing apparatus further comprises an organization state information selecting unit that selects one or more pieces of organization state information that satisfy a predetermined state selection condition from among the two or more pieces of organization state information, and
the output information acquiring unit determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, using the one or more pieces of organization state information selected by the organization state information selecting unit.

7. The information processing apparatus according to claim 1, further comprising:
an action information receiving unit that receives action information regarding an action of a member performed in response to the output information transmitted by the output information transmitting unit;
a statistical processing unit that performs statistical processing on the action information received by the action information receiving unit, to acquire a statistical processing result; and
a statistical processing result output unit that outputs the statistical processing result.

8. The information processing apparatus according to claim 1, further comprising
an action information receiving unit that receives action information regarding an action of a member performed in response to the output information transmitted by the output information transmitting unit,
wherein the output information acquiring unit determines a piece of presentation information that is to be presented to a member of the organization, from among the pieces of presentation information stored in the presentation information storage unit, using the action information received by the action information receiving unit, and
the output information transmitting unit transmits output information that is the piece of presentation information determined by the output information acquiring unit.

9. The information processing apparatus according to claim 8,
wherein the output information transmitted by the output information transmitting unit is associated with organization state information, and
the output information acquiring unit determines a piece of presentation information that is to be presented to a member of the organization, from among the pieces of presentation information stored in the presentation information storage unit, using the action information received by the action information receiving unit and the organization state information associated with the output information.

10. The information processing apparatus according to claim 1,
wherein the organization state information storage unit stores first organization state information as of a first point in time that is earlier than when the output information transmitting unit transmits output information, and second organization state information as of a second point in time that is later than when the output information transmitter transmits output information, and
the information processing apparatus further comprises:
a change information acquiring unit that acquires change information regarding a difference between the first organization state information and the second organization state information; and
a change information output unit that outputs the change information acquired by the change information acquiring unit.

11. The information processing apparatus according to claim 1, further comprising:
an organization state information acquiring unit that analyzes first response information regarding a questionnaire directed to one or more members of the organization as of a first point in time that is earlier than when the output information transmitting unit transmits output information, to acquire first organization state information, and analyzes second response information regarding a questionnaire directed to one or more members of the organization as of a second point in time that is later than when the output information transmitting unit transmits output information, to acquire second organization state information;
a change information acquiring unit that acquires change information regarding a difference between the first organization state information and the second organization state information; and
a change information output unit that outputs the change information acquired by the change information acquiring unit.

12. The information processing apparatus according to claim 1,
wherein the organization state information is any one of one or more types of information of: first type organization state information regarding an overall statistical processing result that is a statistical processing result regarding the entire organization obtained by performing statistical processing on response information regarding a questionnaire directed to two or more members of the organization; second type organization state information regarding a sector statistical processing result that is a statistical processing result obtained by performing statistical processing on response information regarding a questionnaire directed to two or more members of the sector to which two or more members of the organization belong; and third type organization state information regarding a response to a questionnaire directed to each member,
the output information acquiring unit determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, in association with a type identifier that identifies a type corresponding to the organization state information, using the organization state information, and
the output information transmitting unit transmits output information that is the presentation information determined by the output information acquiring unit or the presentation information changed by the output information acquiring unit, in association with the type identifier.

13. An information processing method that can be realized using an organization state information storage unit that stores organization state information regarding a state of an organization, a presentation information storage unit that stores one or more pieces of presentation information that is to be presented to a member of an organization, and a processor, the information processing method comprising:
an output information acquiring step in which the processor determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, using the organization state information; and
an output information transmitting step in which the processor transmits output information that is the presentation information determined in the output information acquiring step or the presentation information changed by the output information acquiring unit.

14. A recording medium on which a program is recorded, the program enabling a computer that can access: an organization state information storage unit that stores organization state information that is information regarding a state of an organization; and a presentation information storage unit that stores one or more pieces of presentation information that are pieces of information to be presented to a member of the organization, to function as:
an output information acquiring unit that determines a piece of presentation information that is to be presented to a member of the organization from among the pieces of presentation information stored in the presentation information storage unit, or changes the pieces of presentation information stored in the presentation information storage unit so as to be in a presentation mode for a member of the organization, using the organization state information; and
an output information transmitting unit that transmits the piece of presentation information determined by the output information acquiring unit or output information that is the presentation information changed by the output information acquiring unit.
